(19) United States
(12) Patent Application Publication
(10) Pub. No.: US 2018/0291140 A1
(43) Pub. Date: Oct. 11, 2018

(54) METHACRYLIC RESIN MOLDED BODY, OPTICAL COMPONENT AND AUTOMOBILE COMPONENT

(71) Applicant: ASAHI KASEI KABUSHIKI KAISHA, Tokyo (JP)

(72) Inventors: Junichi YOSHIDA, Tokyo (JP); Harumi WATANABE, Tokyo (JP); Yutaka TADA, Tokyo (JP)

(73) Assignee: ASAHI KASEI KABUSHIKI KAISHA, Tokyo (JP)

(21) Appl. No.: 15/941,263

(22) Filed: Mar. 30, 2018

(30) Foreign Application Priority Data
Apr. 7, 2017 (JP) 2017-076756

(51) Int. Cl. C08G 61/12

(52) U.S. Cl. CPC C08G 61/127; C08G 61/124; C08G 2261/64; C08G 2261/3342; C08G 2261/60; C08G 2261/12

(57) ABSTRACT

Provided is a methacrylic resin shaped product having high heat resistance, highly controlled birefringence, and excellent color tone and transparency. The methacrylic resin shaped product comprises a methacrylic resin or a composition containing the methacrylic resin. The methacrylic resin includes a structural unit (B) having a cyclic structure including at least one structural unit selected from the group consisting of an N-substituted maleimide structural unit (B-1) and a lactone ring structural unit (B-2) in a main chain, and has a glass transition temperature of higher than 120° C. and not higher than 160° C. Methanol-soluble content in the methacrylic resin is 5 mass % or less relative to 100 mass %, in total, of the methanol-soluble content and methanol-insoluble content. Yellowness index (YI) measured with respect to a 20 w/v % chloroform solution of the methanol-insoluble content using a 10 cm optical path length cell is 0 to 7.

### TECHNICAL FIELD

This disclosure relates to a methacrylic resin shaped product having high heat resistance, highly controlled birefringence, and excellent color tone and transparency, and to an optical or automotive component obtained from this shaped product.

### BACKGROUND

Methacrylic resins excel in terms of transparency, surface hardness, and the like while also having an optical property of low birefringence. Consequently, methacrylic resins have attracted attention in recent years as optical resins suitable for optical materials in various optical products such as liquid-crystal displays, plasma displays, organic EL displays, and other flat panel displays, small-scale infrared sensors, fine optical waveguides, microlenses, pick-up lenses and the like for DVDs and Blu-ray discs that handle short wavelength light, optical discs, optical films, plastic substrates, and so forth, and the market for methacrylic resins is continuing to significantly expand.

In particular, methacrylic resins having cyclic structure-containing main chains and compositions containing such methacrylic resins are known to have excellent performance in terms of both heat resistance and optical properties (for example, refer to PTL 1), and demand for these resins and compositions thereof is rapidly increasing year by year. However, methacrylic resins including cyclic structure-containing main chains that have enhanced heat resistance and optical properties as described above sometimes suffer from problems resulting from their cyclic structure, for example, such as coloring and reduced transmittance through absorption in the visible light region. For this reason, methods of reducing the amount of unreacted cyclic monomer remaining in a methacrylic resin have been disclosed with the aim of obtaining a methacrylic resin including a cyclic structure-containing main chain that has little coloring and high transparency.

For example, PTL 2 proposes a method for reducing the amount of residual N-substituted maleimide monomer and obtaining a heat resistant methacrylic resin having excellent transparency and little coloring by, in a production method in which monomer components including an N-substituted maleimide (a) and a methacrylic acid ester (b) are used by supplying a portion of the monomer components, initiating polymerization, and subsequently supplying the remaining portion of the monomer components partway through polymerization, performing control such that the proportion constituted by the N-substituted maleimide (a) among unreacted monomer components present in the reaction system at the time at which supply of the monomer components is completed is lower than the proportion constituted by the N-substituted maleimide (a) among the total supplied amount of the monomer components.

Furthermore, PTL 3 proposes a method in which, with respect to a polymerization system of a methacrylic acid ester monomer and a maleimide monomer in which a sulfuric chain transfer agent such as a mercaptan is used, an acidic substance is provided in the reaction system such as to reduce the amount of residual maleimide monomer and the amount of maleimide monomer produced through heating in shaping processing or the like, and thereby suppress coloring.

### CITATION LIST

### Patent Literature

PTL 1: WO 2011/149088 A1

PTL 2: JP H9-324016 A

PTL 3: JP 2001-233919 A

### SUMMARY

### Technical Problem

However, in recent years, applications of methacrylic resins have expanded from optical film applications to applications in thicker shaped products such as lenses and molded plates, and thus keen demand has developed for the provision of methacrylic resin shaped products that can display less coloring and higher transparency even in the case of a shaped product having a long optical path length.

PTL 2 and 3 propose solutions that focus on N-substituted maleimide used as a monomer, which has strong coloring ability, and focus on reducing the amount of residual N-substituted maleimide in a methacrylic resin and reducing the amount of N-substituted maleimide due to heat history such as shaping processing as a method of reducing coloring.

However, the enhancement in terms of coloring and transparency is, for example, inadequate for providing a methacrylic resin that is capable of responding to the expanded use in shaped product applications having a long optical path length such as described above.

Consequently, there is strong demand for further enhancement of coloring and transparency of a methacrylic resin by focusing not only on controlling residual coloring monomer, such as N-substituted maleimide, but also on the polymer itself.

An objective of this disclosure is to provide a methacrylic resin shaped product having high heat resistance, highly controlled birefringence, and excellent color tone and transparency.

### Solution to Problem

As a result of diligent studies conducted with the aim of solving the problems experienced by the conventional techniques set forth above, the inventors discovered that these problems can be solved to enable less coloring and higher transparency even in the case of a shaped product having a long optical path length by separating methanol-soluble content and methanol-insoluble content of a methacrylic resin, and controlling properties of these separate components.

Through enhancement of the polymer itself, application in methacrylic resins having cyclic structure-containing main chains is not limited only to resins having a cyclic structure derived from an N-substituted maleimide monomer but is also possible, for example, in resins including a lactone ring structural unit or the like.

Specifically, this disclosure provides the following.

[1] A methacrylic resin shaped product comprising a methacrylic resin or a composition containing the methacrylic resin, wherein

the methacrylic resin includes a structural unit (B) having a cyclic structure including at least one structural unit selected from the group consisting of an N-substituted maleimide structural unit (B-1) and a lactone ring structural unit (B-2) in a main chain,

the methacrylic resin has a glass transition temperature of higher than 120° C. and not higher than 160° C.,

methanol-soluble content in the methacrylic resin is 5 mass % or less relative to 100 mass %, in total, of the methanol-soluble content and methanol-insoluble content, and

yellowness index (YI) measured with respect to a 20 w/v % chloroform solution of the methanol-insoluble content using a 10 cm optical path length cell is 0 to 7.

[2] The methacrylic resin shaped product according to [1], wherein

transmittance at 680 nm measured with respect to a 20 w/v % chloroform solution of the methanol-insoluble content using a 10 cm optical path length cell is 90% or more.

[3] The methacrylic resin shaped product according to [1] or [2], wherein

the methacrylic resin includes 50 mass % to 97 mass % of a methacrylic acid ester monomer unit (A) when the methacrylic resin is taken to be 100 mass %.

[4] The methacrylic resin shaped product according to any one of [1] to [3], wherein

the methacrylic resin includes 3 mass % to 30 mass % of the structural unit (B) having a cyclic structure in a main chain and 0 mass % to 20 mass % of another vinyl monomer unit (C) that is copolymerizable with a methacrylic acid ester monomer when the methacrylic resin is taken to be 100 mass %.

[5] The methacrylic resin shaped product according to any one of [1] to [4], wherein

content of the structural unit (B) is 45 mass % to 100 mass % when the structural unit (B) and the monomer unit (C) are taken to be 100 mass %, in total.

[6] The methacrylic resin shaped product according to [4] or [5], wherein

the monomer unit (C) includes a structural unit of at least one selected from the group consisting of an acrylic acid ester monomer, an aromatic vinyl monomer, and a vinyl cyanide monomer.

[7] The methacrylic resin shaped product according to any one of [1] to [6], wherein

the methacrylic resin has a photoelastic coefficient of −2×10⁻¹² Pa⁻¹ to +2×10⁻¹² Pa⁻¹.

[8] The methacrylic resin shaped product according to any one of [1] to [7], wherein

the methacrylic resin has a ratio (Mz/Mw) of Z average molecular weight (Mz) and weight average molecular weight (Mw) of 1.3 to 2.0 as measured by gel permeation chromatography (GPC).

[9] An optical or automotive component comprising the methacrylic resin shaped product according to any one of [1] to [8].

### Advantageous Effect

According to this disclosure, it is possible to provide a methacrylic resin shaped product having high heat resistance, highly controlled birefringence, and excellent color tone and transparency.

### DETAILED DESCRIPTION

The following provides a detailed description of a presently disclosed embodiment (hereinafter, referred to as the “present embodiment”). However, this disclosure is not limited by the following description and may be implemented with various alterations within the essential scope thereof.

(Methacrylic Resin Shaped Product)

A methacrylic resin shaped product according to the present embodiment comprises a methacrylic resin or a composition containing the methacrylic resin, wherein the methacrylic resin includes a structural unit (B) having a cyclic structure including at least one structural unit selected from the group consisting of an N-substituted maleimide structural unit (B-1) and a lactone ring structural unit (B-2) in a main chain, the methacrylic resin has a glass transition temperature of higher than 120° C. and not higher than 160° C., methanol-soluble content in the methacrylic resin is 5 mass % or less relative to 100 mass %, in total, of the methanol-soluble content and methanol-insoluble content, and yellowness index (YI) measured with respect to a 20 w/v % chloroform solution of the methanol-insoluble content using a 10 cm optical path length cell is 0 to 7.

(Methacrylic Resin)

The methacrylic resin forming the methacrylic resin shaped product according to the present embodiment includes a methacrylic acid ester monomer unit (A) and a structural unit (B) including, in a main chain, at least one cyclic structure selected from the group consisting of an N-substituted maleimide monomer-derived structural unit (B-1) and a lactone ring structural unit (B-2), and may optionally include another vinyl monomer unit (C) that is copolymerizable with a methacrylic acid ester monomer.

The following describes these monomer structural units.

—Methacrylic Acid Ester Monomer-Derived Structural Unit (A)—

First, the methacrylic acid ester monomer-derived structural unit (A) is described.

The methacrylic acid ester monomer-derived structural unit (A) may, for example, be formed from a monomer selected from the methacrylic acid esters listed below.

Examples of methacrylic acid esters that may be used include methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, cyclopentyl methacrylate, cyclohexyl methacrylate, cyclooctyl methacrylate, tricyclodecyl methacrylate, dicyclooctyl methacrylate, tricyclododecyl methacrylate, isobornyl methacrylate, phenyl methacrylate, benzyl methacrylate, 1-phenylethyl methacrylate, 2-phenoxyethyl methacrylate, 3-phenylpropyl methacrylate, and 2,4,6-tribromophenyl methacrylate.

One of these monomers may be used individually, or two or more of these monomers may be used together.

Of these methacrylic acid esters, methyl methacrylate and benzyl methacrylate are preferable in terms that the obtained methacrylic resin has excellent transparency and weatherability.

The methacrylic resin may include one type of methacrylic acid ester monomer-derived structural unit (A), or may include two or more types of methacrylic acid ester monomer-derived structural units (A).

The content of the methacrylic acid ester monomer-derived structural unit (A) relative to 100 mass % of the methacrylic resin is preferably 50 mass % to 97 mass %, more preferably 55 mass % to 97 mass %, even more preferably 55 mass % to 95 mass %, further preferably 60 mass % to 93 mass %, and particularly preferably 60 mass % to 90 mass % from a viewpoint of providing the methacrylic resin with sufficient heat resistance through the subsequently described structural unit (B) having a cyclic structure in a main chain.

The following describes the structural unit (B) having a cyclic structure in a main chain.

—N-Substituted Maleimide Monomer-Derived Structural Unit (B-1)—

Next, the N-substituted maleimide monomer-derived structural unit (B-1) is described.

The N-substituted maleimide monomer-derived structural unit (B-1) may be formed from at least one selected from a monomer represented by the following formula (1) and a monomer represented by the following formula (2), and is preferably formed from both a monomer represented by formula (1) and a monomer represented by formula (2).

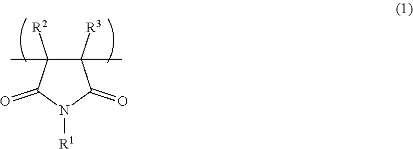

In formula (1), R¹ represents an arylalkyl group having a carbon number of 7 to 14 or an aryl group having a carbon number of 6 to 14, and R² and R³ each represent, independently of one another, a hydrogen atom, an alkyl group having a carbon number of 1 to 12, or an aryl group having a carbon number of 6 to 14.

Moreover, in a case in which R² is an aryl group, R² may include a halogen as a substituent.

Furthermore, R¹ may be substituted with a substituent such as a halogen atom, an alkyl group having a carbon number of 1 to 6, an alkoxy group having a carbon number of 1 to 6, a nitro group, or a benzyl group.

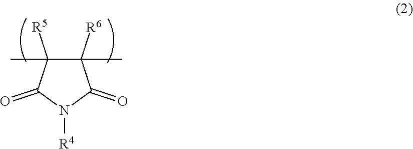

In formula (2), R⁴ represents a hydrogen atom, a cycloalkyl group having a carbon number of 3 to 12, or an alkyl group having a carbon number of 1 to 12, and R⁵ and R⁶ each represent, independently of one another, a hydrogen atom, an alkyl group having a carbon number of 1 to 12, or an aryl group having a carbon number of 6 to 14.

Specific examples are as follows.

Examples of monomers represented by formula (1) include N-phenylmaleimide, N-benzylmaleimide, N-(2-chlorophenyl)maleimide, N-(4-chlorophenyl)maleimide, N-(4-bromophenyl)maleimide, N-(2-methylphenyl)maleimide, N-(2-ethylphenyl)maleimide, N-(2-methoxyphenyl)maleimide, N-(2-nitrophenyl)maleimide, N-(2,4,6-trimethylphenyl)maleimide, N-(4-benzylphenyl)maleimide, N-(2,4,6-tribromophenyl)maleimide, N-naphthylmaleimide, N-anthracenylmaleimide, 3-methyl-1-phenyl-1H-pyrrole-2,5-dione, 3,4-dimethyl-1-phenyl-1H-pyrrole-2,5-dione, 1,3-diphenyl-1H-pyrrole-2,5-dione, and 1,3,4-triphenyl-1H-pyrrole-2,5-dione.

Of these monomers, N-phenylmaleimide and N-benzylmaleimide are preferable in terms that the obtained methacrylic resin has excellent heat resistance and optical properties such as birefringence.

One of these monomers may be used individually, or two or more of these monomers may be used together.

Examples of monomers represented by formula (2) include N-methylmaleimide, N-ethylmaleimide, N-n-propylmaleimide, N-isopropylmaleimide, N-n-butylmaleimide, N-isobutylmaleimide, N-s-butylmaleimide, N-t-butylmaleimide, N-n-pentylmaleimide, N-n-hexylmaleimide, N-n-heptylmaleimide, N-n-octylmaleimide, N-laurylmaleimide, N-stearylmaleimide, N-cyclopentylmaleimide, N-cyclohexylmaleimide, 1-cyclohexyl-3-methyl-1-phenyl-1H-pyrrole-2,5-dione, 1-cyclohexyl-3,4-dimethyl-1-phenyl-1H-pyrrole-2,5-dione, 1-cyclohexyl-3-phenyl-1H-pyrrole-2,5-dione, and 1-cyclohexyl-3,4-diphenyl-1H-pyrrole-2,5-dione.

Of these monomers, N-methylmaleimide, N-ethylmaleimide, N-isopropylmaleimide, and N-cyclohexylmaleimide are preferable in terms of providing the methacrylic resin with excellent weatherability, and N-cyclohexylmaleimide is particularly preferable in terms of providing the excellent low hygroscopicity demanded in optical materials in recent years.

One of these monomers may be used individually, or two or more of these monomers may be used together.

In the methacrylic resin forming the methacrylic resin shaped product according to the present embodiment, it is particularly preferable that a monomer represented by formula (1) and a monomer represented by formula (2) are used together in order to achieve highly controlled birefringence properties.

The molar ratio (B1/B2) of the content (B1) of a structural unit derived from a monomer represented by formula (1) relative to the content (B2) of a structural unit derived from a monomer represented by formula (2) is preferably more than 0 and not more than 15, and more preferably more than 0 and not more than 10.

When the molar ratio B1/B2 is within any of the ranges set forth above, good heat resistance and good photoelastic properties can be achieved while maintaining transparency of the methacrylic resin shaped product according to the present embodiment, without yellowing or loss of environment resistance.

Although the content of the N-substituted maleimide monomer-derived structural unit (B-1) is not specifically limited so long as the resultant composition satisfies the glass transition temperature range according to the present embodiment, the content of the N-substituted maleimide monomer-derived structural unit (B-1) when the methacrylic resin is taken to be 100 mass % is preferably within a range of 5 mass % to 40 mass %, and more preferably within a range of 5 mass % to 35 mass %.

When the content of the N-substituted maleimide monomer-derived structural unit (B-1) is within any of the ranges set forth above, a more sufficient heat resistance enhancement effect can be obtained with respect to the methacrylic resin shaped product and a more preferable enhancement effect can be obtained in terms of weatherability, low water absorbency, and optical properties. Note that setting the content of the N-substituted maleimide monomer-derived structural unit as 40 mass % or less is effective for preventing reduction of physical properties of the methacrylic resin shaped product caused by a decrease in reactivity of monomer components in polymerization reaction and an increase in the amount of unreacted residual monomer.

—Lactone Ring Structural Unit (B-2)—

A methacrylic resin including a lactone ring structural unit in a main chain can be formed by methods such as described in JP 2001-151814 A, JP 2004-168882 A, JP 2005-146084 A, JP 2006-96960 A, JP 2006-171464 A, JP 2007-63541 A, JP 2007-297620 A, and JP 2010-180305 A.

A lactone ring structural unit included in the methacrylic resin forming the methacrylic resin shaped product according to the present embodiment may be formed after resin polymerization.

In the present embodiment, the lactone ring structural unit is preferably a six-membered ring since this provides excellent cyclic structure stability.

The lactone ring structural unit that is a six-membered ring is, for example, particularly preferably a structure represented by the following general formula (3).

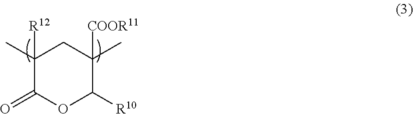

In general formula (3), R¹⁰, R¹¹, and R¹² are each, independently of one another, a hydrogen atom or an organic residue having a carbon number of 1 to 20.

Examples of the organic residue include saturated aliphatic hydrocarbon groups (alkyl groups, etc.) having a carbon number of 1 to 20 such as a methyl group, an ethyl group, and a propyl group; unsaturated aliphatic hydrocarbon groups (alkenyl groups, etc.) having a carbon number of 2 to 20 such as an ethenyl group and a propenyl group; aromatic hydrocarbon groups (aryl groups, etc.) having a carbon number of 6 to 20 such as a phenyl group and a naphthyl group; and groups in which at least one hydrogen atom of any of these saturated aliphatic hydrocarbon groups, unsaturated aliphatic hydrocarbon groups, and aromatic hydrocarbon groups is substituted with at least one group selected from the group consisting of a hydroxy group, a carboxyl group, an ether group, and an ester group.

The lactone ring structure may be formed, for example, by copolymerizing an acrylic acid-based monomer having a hydroxy group and a methacrylic acid ester monomer such as methyl methacrylate to introduce a hydroxy group and an ester group or carboxyl group into the molecular chain, and then causing dealcoholization (esterification) or dehydration condensation (hereinafter, also referred to as a “cyclocondensation reaction”) between the hydroxy group and the ester group or carboxyl group.

Examples of acrylic acid-based monomers having a hydroxy group that may be used in polymerization include 2-(hydroxymethyl)acrylic acid, 2-(hydroxyethyl)acrylic acid, alkyl 2-(hydroxymethyl)acrylates (for example, methyl 2-(hydroxymethyl)acrylate, ethyl 2-(hydroxymethyl)acrylate, isopropyl 2-(hydroxymethyl)acrylate, n-butyl 2-(hydroxymethyl)acrylate, and t-butyl 2-(hydroxymethyl)acrylate) and alkyl 2-(hydroxyethyl)acrylates. Moreover, 2-(hydroxymethyl)acrylic acid and alkyl 2-(hydroxymethyl)acrylates that are monomers having a hydroxyallyl moiety are preferable, and methyl 2-(hydroxymethyl)acrylate and ethyl 2-(hydroxymethyl)acrylate are particularly preferable.

Although no specific limitations are placed on the content of the lactone ring structural unit in the case of a methacrylic resin including a lactone ring structural unit in a main chain so long as the glass transition temperature range for the methacrylic resin according to the present embodiment is satisfied, the content of the lactone ring structural unit relative to 100 mass % of the methacrylic resin is preferably 5 mass % to 40 mass %, and more preferably 5 mass % to 35 mass %.

When the content of the lactone ring structural unit is within any of the ranges set forth above, effects resulting from introduction of a cyclic structure, such as improved solvent resistance and improved surface hardness, can be expressed while maintaining shaping processability.

Note that the content of a lactone ring structure in a methacrylic resin can be determined by a method described in the previously mentioned patent literature.

From a viewpoint of heat resistance, thermal stability, strength, and fluidity of the methacrylic resin forming the methacrylic resin shaped product according to the present embodiment, the content of the structural unit (B) having a cyclic structure in a main chain relative to 100 mass % of the methacrylic resin is preferably 3 mass % to 40 mass %. The lower limit for this content is more preferably 5 mass % or more, even more preferably 7 mass % or more, and further preferably 8 mass % or more, and the upper limit for this content is more preferably 30 mass % or less, even more preferably 28 mass % or less, further preferably 25 mass % or less, even further preferably 20 mass % or less, particularly preferably 18 mass % or less, and most preferably less than 15 mass %.

—Other Vinyl Monomer Units (C) Copolymerizable with Methacrylic Acid Ester Monomer—

Examples of other vinyl monomer units (C) copolymerizable with a methacrylic acid ester monomer that may be included in the methacrylic resin forming the methacrylic resin shaped product according to the present embodiment (hereinafter, also referred to as monomer units (C)) include an aromatic vinyl monomer unit (C-1), an acrylic acid ester monomer unit (C-2), a vinyl cyanide monomer unit (C-3), and other monomer units (C-4).

One type of other vinyl monomer unit (C) that is copolymerizable with a methacrylic acid ester monomer may be used individually, or two or more types of other vinyl monomer units (C) that are copolymerizable with a methacrylic acid ester monomer may be used in combination.

An appropriate material for the monomer unit (C) can be selected depending on the properties required of the methacrylic resin forming the methacrylic resin shaped product according to the present embodiment, but in a case in which properties such as thermal stability, fluidity, mechanical properties, and chemical resistance are particularly necessary, at least one selected from the group consisting of an aromatic vinyl monomer unit (C-1), an acrylic acid ester monomer unit (C-2), and a vinyl cyanide monomer unit (C-3) is suitable.

[Aromatic Vinyl Monomer Unit (C-1)]

Although no specific limitations are placed on monomers that can be used to form an aromatic vinyl monomer unit (C-1) included in the methacrylic resin forming the methacrylic resin shaped product according to the present embodiment, an aromatic vinyl monomer represented by the following general formula (4) is preferable.

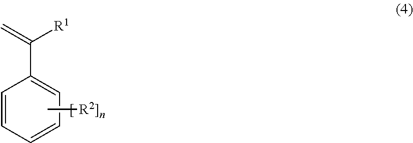

In general formula (4), R¹ represents a hydrogen atom or an alkyl group having a carbon number of 1 to 6. The alkyl group may, for example, be substituted with a hydroxy group.

R² is one selected from the group consisting of a hydrogen atom, an alkyl group having a carbon number of 1 to 12, an alkoxy group having a carbon number of 1 to 12, an aryl group having a carbon number of 6 to 8, and an aryloxy group having a carbon number of 6 to 8. Note that each R² may be the same group or a different group. Also, R² groups may form a cyclic structure together.

Moreover, n represents an integer of 0 to 5.

Specific examples of monomers represented by general formula (4) include, but are not specifically limited to, styrene, o-methylstyrene, m-methylstyrene, p-methylstyrene, 2,4-dimethylstyrene, 2,5-dimethylstyrene, 3,4-dimethylstyrene, 3,5-dimethylstyrene, p-ethylstyrene, m-ethylstyrene, o-ethylstyrene, p-tert-butylstyrene, 1-vinylnaphthalene, 2-vinylnaphthalene, 1,1-diphenyl ethylene, isopropenylbenzene (α-methylstyrene), isopropenyltoluene, isopropenylethylbenzene, isopropenylpropylbenzene, isopropenylbutylbenzene, isopropenylpentylbenzene, isopropenylhexylbenzene, isopropenyloctylbenzene, a-hydroxymethylstyrene, and α-hydroxyethylstyrene.

Of these examples, styrene and isopropenylbenzene are preferable, and styrene is more preferable from a viewpoint of imparting fluidity, reducing unreacted monomer through improvement of the polymerization conversion rate, and so forth.

The above examples may be selected as appropriate depending on the required properties of the methacrylic resin according to the present embodiment.

In a case in which an aromatic vinyl monomer unit (C-1) is used, the content thereof when the total amount of the monomer unit (A) and the structural unit (B) is taken to be 100 mass % is preferably 23 mass % or less, more preferably 20 mass % or less, even more preferably 18 mass % or less, further preferably 15 mass % or less, and even further preferably 10 mass % or less in consideration of the balance of heat resistance, residual monomer species reduction, and fluidity.

In a case in which an aromatic vinyl monomer unit (C-1) is used together with the maleimide-based structural unit (B-1) described above, a ratio (mass ratio) of the content of the monomer unit (C-1) relative to the content of the structural unit (B-1) (i.e., (C-1) content/(B-1) content) is preferably 0.3 to 5 from a viewpoint of processing fluidity in film shaping processing, an effect of silver streak reduction through residual monomer reduction, and so forth.

The upper limit for this ratio is preferably 5 or less, more preferably 3 or less, and even more preferably 1 or less from a viewpoint of maintaining good color tone and heat resistance. Moreover, the lower limit for this ratio is preferably 0.3 or more, and more preferably 0.4 or more from a viewpoint of residual monomer reduction.

One aromatic vinyl monomer (C-1) such as described above may be used individually, or two or more aromatic vinyl monomers (C-1) such as described above may be used in combination.

[Acrylic Acid Ester Monomer Unit (C-2)]

Although no specific limitations are placed on monomers that may be used to form an acrylic acid ester monomer unit (C-2) included in the methacrylic resin forming the methacrylic resin shaped product according to the present embodiment, an acrylic acid ester monomer represented by the following general formula (5) is preferable.

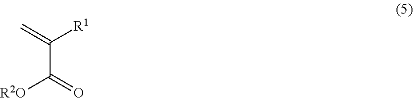

In general formula (5), R¹ represents a hydrogen atom or an alkoxy group having a carbon number of 1 to 12, and R² represents an alkyl group having a carbon number of 1 to 18, a cycloalkyl group having a carbon number of 3 to 12, or an aryl group having a carbon number of 6 to 14.

The monomer used to form the acrylic acid ester monomer unit (C-2) is preferably methyl acrylate, ethyl acrylate, n-propyl acrylate, isopropyl acrylate, n-butyl acrylate, sec-butyl acrylate, 2-ethylhexyl acrylate, cyclohexyl acrylate, phenyl acrylate, or the like, and more preferably methyl acrylate, ethyl acrylate, or n-butyl acrylate from a viewpoint of increasing weatherability, heat resistance, fluidity, and thermal stability in the case of a methacrylic resin for a film according to the present embodiment, and is even more preferably methyl acrylate or ethyl acrylate from a viewpoint of ease of acquisition.

One type of acrylic acid ester monomer unit (C-2) such as described above may be used individually, or two or more types of acrylic acid ester monomer units (C-2) such as described above may be used together.

In a case in which an acrylic acid ester monomer unit (C-2) is used, the content thereof when the total amount of the monomer unit (A) and the structural unit (B) is taken to be 100 mass % is preferably 5 mass % or less, and more preferably 3 mass % or less from a viewpoint of heat resistance and thermal stability.

[Vinyl Cyanide Monomer Unit (C-3)]

Examples of monomers that may be used to form a vinyl cyanide monomer unit (C-3) included in the methacrylic resin forming the methacrylic resin shaped product according to the present embodiment include, but are not specifically limited to, acrylonitrile, methacrylonitrile, ethacrylonitrile, and vinylidene cyanide. Of these examples, acrylonitrile is preferable from a viewpoint of ease of acquisition and imparting chemical resistance.

One type of vinyl cyanide monomer unit (C-3) such as described above may be used individually, or two or more types of vinyl cyanide monomer units (C-3) such as described above may be used together.

In a case in which a vinyl cyanide monomer unit (C-3) is used, the content thereof when the total amount of the monomer unit (A) and the structural unit (B) is taken to be 100 mass % is preferably 15 mass % or less, more preferably 12 mass % or less, and even more preferably 10 mass % or less from a viewpoint of solvent resistance and retention of heat resistance.

[Monomer Unit (C-4) Other than (C-1) to (C-3)]

Examples of monomers that may be used to form a monomer unit (C-4) other than (C-1) to (C-3) that is included in the methacrylic resin forming the methacrylic resin shaped product according to the present embodiment include, but are not specifically limited to, amides such as acrylamide and methacrylamide; glycidyl compounds such as glycidyl (meth)acrylate and allyl glycidyl ether; unsaturated carboxylic acids such as acrylic acid, methacrylic acid, itaconic acid, maleic acid, and fumaric acid, and half-esterified products and anhydrides thereof; unsaturated alcohols such as methallyl alcohol and allyl alcohol; olefins such as ethylene, propylene, and 4-methyl-1-pentene; and vinyl compounds and vinylidene compounds other than those described above such as vinyl acetate, 2-hydroxymethyl-1-butene, methyl vinyl ketone, N-vinylpyrrolidone, and N-vinylcarbazole.

Examples of crosslinkable compounds including a plurality of reactive double bonds that may be used include products obtained through esterification of both terminal hydroxy groups of ethylene glycol or an oligomer thereof with acrylic acid or methacrylic acid such as ethylene glycol di(meth)acrylate, diethylene glycol di(meth)acrylate, triethylene glycol di(meth)acrylate, and tetraethylene glycol di(meth)acrylate; products obtained through esterification of two alcohol hydroxy groups with acrylic acid or methacrylic acid such as neopentyl glycol di(meth)acrylate and di(meth)acrylates; products obtained through esterification of polyhydric alcohol derivatives such as trimethylol propane and pentaerythritol with acrylic acid or methacrylic acid; and polyfunctional monomers such as divinylbenzene.

Among the monomers described above that may be used to form the monomer unit (C), at least one selected from the group consisting of methyl acrylate, ethyl acrylate, styrene, and acrylonitrile is preferable from a viewpoint of ease of acquisition.

The content of the other vinyl monomer unit (C) that is copolymerizable with a methacrylic acid ester monomer when the methacrylic resin is taken to be 100 mass % is 0 mass % to 20 mass %, preferably 0 mass % to 18 mass %, and more preferably 0 mass % to 15 mass % from a viewpoint of increasing the effect of imparting heat resistance through the structural unit (B).

Particularly in a case in which a crosslinkable polyfunctional (meth)acrylate having a plurality of reactive double bonds is used for the monomer unit (C), the content of the monomer unit (C) is preferably 0.5 mass % or less, more preferably 0.3 mass % or less, and even more preferably 0.2 mass % or less from a viewpoint of polymer fluidity.

In the present embodiment, the content of the structural unit (B) when the total amount of the structural unit (B) and the monomer unit (C) is taken to be 100 mass % is 45 mass % to 100 mass % from a viewpoint of heat resistance and optical properties of the methacrylic resin shaped product. In such a case, the content of the monomer unit (C) is 0 mass % to 55 mass %. Moreover, the content of the structural unit (B) is preferably 50 mass % to 100 mass %, more preferably 50 mass % to 90 mass %, and even more preferably 50 mass % to 80 mass %.

The following describes properties of the methacrylic resin forming the methacrylic resin shaped product according to the present embodiment.

The glass transition temperature (Tg) of the methacrylic resin forming the methacrylic resin shaped product according to the present embodiment is higher than 120° C. and not higher than 160° C.

As a result of the glass transition temperature of the methacrylic resin being higher than 120° C., it is easier to adequately obtain the heat resistance that has been required in recent years for optical components such as lens shaped products, automotive components such as on-board displays, and film shaped product optical films for liquid-crystal displays. The glass transition temperature (Tg) is more preferably 125° C. or higher, and even more preferably 130° C. or higher from a viewpoint of dimensional stability at temperatures in the environment of use of the methacrylic resin.

On the other hand, as a result of the glass transition temperature (Tg) of the methacrylic resin being 160° C. or lower, it is possible to avoid melt processing at extremely high temperature, inhibit thermal decomposition of resin and the like, and obtain a good product. The glass transition temperature (Tg) is preferably 150° C. or lower for the same reason.

The glass transition temperature (Tg) can be determined through measurement in accordance with JIS K 7121. Specifically, the glass transition temperature (Tg) can be measured by a method described in the subsequent EXAMPLES section.

Methanol-soluble content in the methacrylic resin forming the methacrylic resin shaped product according to the present embodiment as a proportion relative to 100 mass %, in total, of methanol-soluble content and methanol-insoluble content is more than 0 mass % and not more than 5 mass %, preferably at least 0.1 mass % and not more than 4.5 mass %, more preferably at least 0.1 mass % and not more than 4 mass %, even more preferably at least 0.1 mass % and not more than 3.5 mass %, further preferably at least 0.2 mass % and not more than 3 mass %, and even further preferably at least 0.3 mass % and not more than 2.5 mass %.

As a result of the proportion of soluble content being 5 mass % or less, problems during shaping such as casting roller staining during film shaping and the occurrence of silver streaks during injection molding can be inhibited, and the color tone of the shaped product can be enhanced. Reducing components of comparatively low molecular weight that have a high tendency to move to the surface of a shaped product is thought to inhibit problems during shaping. Moreover, by reducing low molecular weight components that tend to absorb visible light in a short wavelength region of 500 nm or less, it is possible to enhance the color tone of the shaped product.

Note that “methanol-soluble content” and “methanol-insoluble content” are obtained by preparing a chloroform solution of the methacrylic resin, subsequently dripping the chloroform solution into methanol to perform re-precipitation, separating a filtrate and a filtration residue, and then drying the filtrate and the filtration residue. Specifically, the methanol-soluble content and the methanol-insoluble content can be obtained by a method described in the subsequent EXAMPLES section.

The methanol-soluble content includes unreacted monomers that remain without reacting in a polymerization step, oligomers and low molecular weight components having a molecular weight on the scale of hundreds to thousands that are produced in the polymerization step, and pyrolytic products such as monomers, oligomers, and low molecular weight components that are produced in a devolatilization step, and, in particular, includes impurities that are composed of low-volatility components among the preceding examples.

Yellowness index (YI) measured with respect to a 20 w/v % chloroform solution of methanol-insoluble content in the methacrylic resin forming the methacrylic resin shaped product according to the present embodiment using a 10 cm optical path length cell is 0 to 7, preferably 0.5 to 6, more preferably 0.8 to 5, and even more preferably 1 to 4.

The transmittance at 680 nm of the methacrylic resin forming the methacrylic resin shaped product according to the present embodiment as measured under the same conditions as in measurement of YI is preferably 90% or more, more preferably 91% or more, and even more preferably 92% or more.

When the yellowness index (YI) and the transmittance are within any of the ranges set forth above, it is possible to obtain a shaped product that is suitable for optical applications.

The yellowness index (YI) and the transmittance can be measured by methods described in the subsequent EXAMPLES section.

It is presumed that light scattering due to contaminants such as gel and copolymer components of non-uniform refractive index acts as a cause of reduction of light transmittance of a shaped product. Such components become included in methanol-insoluble content. Therefore, it is thought that a shaped product having high light transmittance can be obtained when the transmittance of methanol-insoluble content at a wavelength of 680 nm (i.e., light transmittance in a high wavelength region of the visible light band) is high. Moreover, when YI of methanol-insoluble content is small (i.e., when light transmittance in a wavelength region corresponding to blue in the visible light band is high and therefore yellowish coloration, which is the complementary color to blue, is low), it is possible to obtain a resin having high light transmittance and good color tone as a shaped product. Moreover, when transmittance of methanol-insoluble content at 680 nm is high and YI of methanol-insoluble content is low, a shaped product having high light transmittance from high wavelengths to low wavelengths and thus having excellent light transmission properties can be obtained.

The polymethyl methacrylate equivalent weight average molecular weight (Mw) of the methacrylic resin forming the methacrylic resin shaped product according to the present embodiment as measured by gel permeation chromatography (GPC) is preferably within a range of 65,000 to 300,000, more preferably within a range of 100,000 to 220,000, and even more preferably within a range of 120,000 to 180,000.

A weight average molecular weight (Mw) that is within any of the ranges set forth above enables an excellent balance of mechanical strength and fluidity.

In terms of ratios of Z average molecular weight (Mz), weight average molecular weight (Mw), and number average molecular weight (Mn), which serve as parameters expressing the molecular weight distribution, for the methacrylic resin according to the present embodiment, Mw/Mn is preferably 1.5 to 3.0, more preferably 1.6 to 2.5, and even more preferably 1.6 to 2.3, and Mz/Mw is preferably 1.3 to 2.0, more preferably 1.3 to 1.8, and even more preferably 1.4 to 1.7 in consideration of the balance of fluidity and mechanical strength.

In particular, the methacrylic resin can be provided with excellent color tone when Mz/Mw is within any of the ranges set forth above.

The Z average molecular weight, weight average molecular weight, and number average molecular weight of a methacrylic resin can be measured by a method described in the subsequent EXAMPLES section.

The absolute value of the photoelastic coefficient C_{R} of the methacrylic resin including a structural unit (B) having a cyclic structure in a main chain that forms the methacrylic resin shaped product according to the present embodiment is preferably 3.0×10⁻¹² Pa⁻¹ or less, more preferably 2.0×10⁻¹² Pa⁻¹ or less, and even more preferably 1.0×10⁻¹² Pa⁻¹ or less.

The photoelastic coefficient is described in various documents (for example, refer to Review of Chemistry, No. 39, 1998 (published by Japan Scientific Societies Press)) and is defined by the following formulae (i-a) and (i-b). The closer the value of the photoelastic coefficient C_{R} is to zero, the smaller the change in birefringence caused by external force.

C_{R}=|Δn|σ_{R} (i-a)

|Δn|=|nx−ny| (i-b)

(In the above formulae, C_{R} represents the photoelastic coefficient, σ_{R} represents tensile stress, |Δn| represents the absolute value of birefringence, nx represents the refractive index of the tension direction, and ny represents the refractive index of an in-plane direction that is perpendicular to the tension direction.)

When the absolute value of the photoelastic coefficient C_{R} of the methacrylic resin according to the present embodiment is 3.0×10⁻¹² Pa⁻¹ or less, even in a case in which the methacrylic resin is used to form a film that is used in a liquid-crystal display, it is possible to inhibit or prevent the occurrence of non-uniform retardation, reduction of contrast at the periphery of a display screen, and the occurrence of light leakage.

The photoelastic coefficient C_{R} of a methacrylic resin may, more specifically, be determined by a method described in the subsequent EXAMPLES section.

(Production Method of Methacrylic Resin)

The following describes the production method of the methacrylic resin forming the methacrylic resin shaped product according to the present embodiment.

Examples of methods by which the methacrylic resin forming the methacrylic resin shaped product according to the present embodiment may be produced include methods according to a first aspect and a second aspect described below.

According to the first aspect, in a method of radical polymerization of two or more monomers including a methacrylic acid ester monomer by a batch or semi-batch process in a solvent, an initiator having a half-life of at least 1 minute and less than 60 minutes at the polymerization temperature is used as a radical polymerization initiator, the radical polymerization initiator is added into a reactor such that polymerization of the monomers proceeds while gradually reducing the additive amount of the radical polymerization initiator per unit time, and the additive amount of the radical polymerization initiator that is added at or after a point at which the polymerization conversion rate reaches 85% is set as 10 mass % to 25 mass % when the total additive amount of the radical polymerization initiator is taken to be 100 mass %.

Note that in the first aspect, the radical polymerization initiator may be added continuously or intermittently, and in a case in which the radical polymerization initiator is added intermittently, the additive amount per unit time during periods in which addition is not performed is not considered.

According to the second aspect, in a method of radical polymerization of two or more monomer components including a methacrylic acid ester monomer by a batch or semi-batch process in a solvent, an initiator having a half-life of 60 minutes or more at the polymerization temperature is used as a radical polymerization initiator, 25 mass % or more of the total additive amount of the radical polymerization initiator is added not more than 30 minutes from the start of addition of the polymerization initiator, and 25 mass % or more of the total additive amount of the monomers is added at least 30 minutes from the start of addition of the polymerization initiator.

In a case in which the temperature varies during polymerization, the temporal average of the polymerization temperature up until the polymerization conversion rate reaches 95% is taken to be the polymerization temperature.

The following provides a detailed description of a method of producing a methacrylic resin that includes an N-substituted maleimide structural unit (B-1) as the structural unit (B) having a cyclic structure in a main chain.

A solution polymerization method is used as a production method of the methacrylic resin including an N-substituted maleimide monomer-derived structural unit (B-1) in a main chain that forms the methacrylic resin shaped product according to the present embodiment.

The mode of polymerization in the production method according to the present embodiment may be a batch process or a semi-batch process. A batch process is a process in which a reaction is initiated and carried out once the total amount of raw materials has been charged into a reactor, and in which a product is collected after the reaction has ended. A semi-batch process is a process in which either charging of raw materials or collection of product is carried out while a reaction is in progress. The production method of the methacrylic resin including an N-substituted maleimide monomer-derived structural unit in a main chain according to the present embodiment is preferably a semi-batch process in which part of raw material charging is carried out after a reaction has started.

Polymerization of monomers by radical polymerization is used in the production method of the methacrylic resin forming the methacrylic resin shaped product according to the present embodiment.

No specific limitations are placed on the polymerization solvent that is used other than being a solvent that can increase the solubility of a maleimide copolymer obtained through polymerization and maintain appropriate reaction liquid viscosity for objectives such as preventing gelation.

Specific examples of polymerization solvents that may be used include aromatic hydrocarbons such as toluene, xylene, ethylbenzene, and isopropylbenzene; ketones such as methyl isobutyl ketone, butyl cellosolve, methyl ethyl ketone, and cyclohexanone; and polar solvents such as dimethylformamide and 2-methylpyrrolidone.

An alcohol such as methanol, ethanol, or isopropanol may also be used in combination as the polymerization solvent to the extent that solubility of polymerization product in polymerization is not impaired.

The amount of solvent in polymerization is not specifically limited so long as polymerization can proceed without precipitation of copolymer or used monomers in production, or the like, and so long as solvent can easily be removed. For example, the amount of solvent may be 10 parts by mass to 200 parts by mass when the total amount of used monomer is taken to be 100 parts by mass. The amount of solvent is more preferably 25 parts by mass to 200 parts by mass, even more preferably 50 parts by mass to 200 parts by mass, and further preferably 50 parts by mass to 150 parts by mass.

Although no specific limitations are placed on the polymerization temperature other than being a temperature at which polymerization proceeds, the polymerization temperature is preferably 70° C. to 180° C., more preferably 80° C. to 160° C., even more preferably 90° C. to 150° C., and further preferably 100° C. to 150° C. A polymerization temperature of 70° C. or higher is preferable from a viewpoint of productivity, whereas a polymerization temperature of 180° C. or lower is preferable for inhibiting side reactions in polymerization and obtaining a polymer of desired molecular weight and quality.

Although no specific limitations are placed on the polymerization time other than being a time that enables the required degree of polymerization with the required conversion rate, the polymerization time is preferably 2 hours to 15 hours, more preferably 3 hours to 12 hours, and even more preferably 4 hours to 10 hours from a viewpoint of productivity and the like.

The polymerization conversion rate at the end of polymerization of the methacrylic resin including an N-substituted maleimide monomer-derived structural unit in a main chain that forms the methacrylic resin shaped product according to the present embodiment is preferably 93% to 99.9%, more preferably 95% to 99.5%, and even more preferably 97% to 99%.

The polymerization conversion rate is a value obtained by subtracting the total mass of monomer remaining at the end of polymerization from the total mass of monomer added to the polymerization system, calculated as a proportion relative to the total mass of monomer added to the polymerization system.

The amount of N-substituted maleimide monomer remaining in the solution after polymerization (residual amount of N-substituted maleimide) is preferably 100 mass ppm to 7,000 mass ppm, more preferably 200 mass ppm to 5,000 mass ppm, and even more preferably 300 mass ppm to 3,000 mass ppm.

A higher polymerization conversion rate and a smaller residual amount of N-substituted maleimide reduce the amount of monomer that passes around a solvent collection system, and thereby reduce the load of a purification system. However, when the polymerization conversion rate is set excessively high or the residual amount of N-substituted maleimide is set excessively low, although output increases and economic advantage is obtained, the amount of coloring low molecular weight components and the amount of methanol-soluble content may increase, and color tone and shaping processability may be negatively affected.

In the polymerization reaction, polymerization may be performed with addition of a chain transfer agent as necessary.

The chain transfer agent may be a chain transfer agent that is commonly used in radical polymerization and examples thereof include mercaptan compounds such as n-butyl mercaptan, n-octyl mercaptan, n-decyl mercaptan, n-dodecyl mercaptan, and 2-ethylhexyl thioglycolate; halogen compounds such as carbon tetrachloride, methylene chloride, and bromoform; and unsaturated hydrocarbon compounds such as α-methylstyrene dimer, a-terpinene, dipentene, and terpinolene.

One of these chain transfer agents may be used individually, or two or more of these chain transfer agents may be used together.

These chain transfer agents may be added at any stage, without any specific limitations, so long as the polymerization reaction is in progress.

The additive amount of the chain transfer agent when the total amount of monomer used in polymerization is taken to be 100 parts by mass may be 0.01 parts by mass to 1 part by mass, and is preferably 0.05 parts by mass to 0.5 parts by mass.

In solution polymerization, it is important to reduce the concentration of dissolved oxygen in the polymerization solution as much as possible in advance. For example, the concentration of dissolved oxygen is preferably 10 ppm or less.

The concentration of dissolved oxygen can be measured, for example, using a dissolved oxygen (DO) meter B-505 (produced by Iijima Electronics Corporation). The method by which the concentration of dissolved oxygen is reduced may be selected as appropriate from methods such as a method in which an inert gas is bubbled into the polymerization solution; a method in which an operation of pressurizing the inside of a vessel containing the polymerization solution to approximately 0.2 MPa with an inert gas and then releasing the pressure is repeated prior to polymerization; and a method in which an inert gas is passed through a vessel containing the polymerization solution.

A polymerization initiator is added in the polymerization reaction.

The polymerization initiator may be any initiator that is commonly used in radical polymerization and examples thereof include organic peroxides such as cumene hydroperoxide, diisopropylbenzene hydroperoxide, di-t-butyl peroxide, lauroyl peroxide, benzoyl peroxide, t-butylperoxy isopropyl carbonate, t-amyl peroxy-2-ethylhexanoate, t-amyl peroxyisononanoate, and 1,1-di(t-butylperoxy)cyclohexane; and azo compounds such as 2,2′-azobis(isobutyronitrile), 1,1′-azobis(cyclohexanecarbonitrile), 2,2′-azobis(2,4-dimethylvaleronitrile), and dimethyl-2,2′-azobisisobutyrate.

One of these polymerization initiators may be used individually, or two or more of these polymerization initiators may be used together.

These polymerization initiators may be added at any stage so long as the polymerization reaction is in progress.

The additive amount of the polymerization initiator when the total amount of monomer used in polymerization is taken to be 100 parts by mass may be 0.01 parts by mass to 1 part by mass, and is preferably 0.05 parts by mass to 0.5 parts by mass.

In polymerization of the methacrylic resin including an N-substituted maleimide monomer-derived cyclic structural unit that forms the methacrylic resin shaped product according to the present embodiment, it is possible to produce a methacrylic resin in which methanol-soluble content is 5 mass % or less relative to 100 mass %, in total, of methanol-soluble content and methanol-insoluble content, and for which yellowness index (YI) measured with respect to a 20 w/v % chloroform solution of methanol-insoluble content using a 10 cm optical path length cell is 0 to 7 by controlling the concentration of each comonomer and radicals having polymerization activity that are present in the reaction system.

If an attempt is made to increase the conversion rate at the end of polymerization in typical batch radical polymerization, the amount of oligomer components in a final stage of polymerization increases and shaping processability is negatively affected. Moreover, in copolymerization of a methacrylic acid ester monomer and an N-substituted maleimide monomer, the N-substituted maleimide monomer generally has a high tendency to remain, leading to production of low molecular weight polymer having high N-substituted maleimide content in a final stage of polymerization. The low molecular weight polymer itself displays coloring ability, and polymer that acts as a coloring component may also be produced upon heating.

By adding polymerization initiator and/or monomer partway through polymerization and controlling the additive amount thereof in polymerization of the methacrylic resin including an N-substituted maleimide monomer-derived cyclic structural unit that forms the methacrylic resin shaped product according to the present embodiment, it is possible to reduce variation in the concentration ratio of monomer and radicals in the system during polymerization, inhibit the production of low molecular weight components in a final stage of polymerization, and enhance coloring and shaping processability.

In a first polymerization method, an initiator having a half-life of at least 1 minute and less than 60 minutes at the polymerization temperature is used as a radical polymerization initiator in polymerization by a batch process or a semi-batch process, and the radical polymerization initiator is added into a reactor such that polymerization of monomers proceeds while gradually reducing the additive amount of the radical polymerization initiator per unit time.

In a second polymerization method, an initiator having a half-life of 60 minutes or more at the polymerization temperature is used as a radical polymerization initiator in polymerization by a batch process or a semi-batch process, and polymerization is carried out by adding a portion of the radical polymerization initiator into a reactor not more than a specific time after the start of polymerization, and adding a portion of monomer at least a specific time after the start of polymerization.

The following describes these polymerization methods.

As described above, the first polymerization method is a method in which an initiator having a half-life of at least 1 minute and less than 60 minutes at the polymerization temperature is used as a radical polymerization initiator, and the radical polymerization initiator is added into a reactor such that polymerization of monomers proceeds while gradually reducing the additive amount of the radical polymerization initiator per unit time.

The radical polymerization initiator having a half-life of at least 1 minute and less than 60 minutes at the polymerization temperature is, in other words, a radical polymerization initiator for which the polymerization temperature is higher than the one-hour half-life temperature thereof but not higher than the one-minute half-life temperature thereof.

It is preferable that the initiator has a half-life of 1 minute or more at the polymerization temperature because this enables decomposition of the initiator and initiation of polymerization to occur after the initiator has been added into the polymerization reactor and sufficiently mixed with the contents thereof. Moreover, by adding an initiator having a half-life that is significantly shorter than the polymerization time during polymerization, it is possible to maintain low variation in the ratio of residual monomer concentration relative to radical concentration in the reaction system, maintain a low radical concentration in a final stage of polymerization in which the residual monomer concentration has decreased, and thereby inhibit production of low molecular weight components during polymerization.

The half-life of the radical polymerization initiator at the polymerization temperature is preferably at least 3 minutes and less than 60 minutes, and more preferably at least 5 minutes and less than 60 minutes.

Note that the one-minute half-life temperature and one-hour half-life temperature mentioned above are described in the literature, technical documents of peroxide manufacturers, and forth, and the half-life temperatures for other times can be calculated using decomposition reaction activation energy data.

Examples of half-life temperatures of various radical initiators are shown in Table 1.

TABLE 1

| | | Half-life temperature (° C.) | | | | | | |
|---|---|---|---|---|---|---|---|---|
| | Compound name | 1 min | 3 min | 5 min | 1 hr | 2 hr | 3 hr | 10 hr |
| Peroxyesters | 3-Hydroxy-1,1-dimethylbutyl peroxyneodecanoate | 91 | 80 | 76 | 54 | 49 | 46 | 37 |
| | α-Cumyl peroxyneodecanoate | 94 | 83 | 78 | 55 | 49 | 46 | 37 |
| | 1,1,3,3-Tetramethylbutyl peroxyneodecanoate | 92 | 82 | 78 | 58 | 52 | 49 | 41 |
| | 1,1,3,3-Tetramethylbutyl peroxy-2-ethylhexanoate | 124 | 113 | 108 | 84 | 78 | 75 | 65 |
| | t-Butyl peroxyneodecanoate | 104 | 92 | 87 | 65 | 59 | 56 | 46 |
| | t-Butyl peroxypivalate | 110 | 100 | 95 | 73 | 67 | 64 | 55 |
| | t-Butyl peroxy-2-ethylhexanoate | 134 | 122 | 116 | 92 | 86 | 82 | 72 |
| | t-Butyl peroxyisobutyrate | 127 | 121 | 116 | 95 | 86 | 83 | 79 |
| | t-Butyl peroxyacetate | 160 | 149 | 144 | 121 | 115 | 112 | 102 |
| | t-Butyl peroxy-3,5,5-trimethylhexanoate | 166 | 152 | 146 | 119 | 112 | 108 | 97 |
| | t-Butyl peroxyisononanoate | 167 | 154 | 149 | 123 | 117 | 113 | 102 |
| | t-Amyl peroxyneodecanoate | 99 | 89 | 84 | 64 | 58 | 55 | 46 |
| | t-Amyl peroxypivalate | 112 | 101 | 96 | 74 | 68 | 65 | 55 |
| | t-Amyl peroxy-2-ethylhexanoate | 125 | 112 | 108 | 88 | 83 | 80 | 70 |
| | t-Amyl peroxy-n-octoate | 157 | 145 | 140 | 116 | 110 | 106 | 96 |
| | t-Amyl peroxyacetate | 162 | 150 | 144 | 120 | 114 | 110 | 100 |
| | t-Amyl peroxyisononanoate | 152 | 141 | 136 | 114 | 109 | 105 | 96 |
| | t-Amyl peroxybenzoate | 166 | 153 | 147 | 122 | 115 | 111 | 100 |
| | t-Butyl peroxy-2-ethylhexyl monocarbonate | 161 | 149 | 144 | 119 | 113 | 109 | 99 |
| | t-Hexyl peroxyneodecanoate | 101 | 90 | 85 | 63 | 57 | 54 | 45 |
| | t-Butyl peroxyneoheptanoate | 105 | 94 | 89 | 68 | 63 | 60 | 51 |
| | t-Hexyl peroxypivalate | 109 | 98 | 93 | 71 | 66 | 62 | 53 |
| | 2,5-Dimethyl-2,5-di(2-ethylhexanoylperoxy)hexane | 119 | 109 | 104 | 83 | 78 | 75 | 66 |
| | t-Hexyl peroxy-2-ethylhexanoate | 133 | 120 | 115 | 90 | 84 | 80 | 70 |
| | t-Hexyl peroxy isopropyl monocarbonate | 155 | 143 | 138 | 115 | 108 | 105 | 95 |
| | t-Butyl peroxy maleic acid | 168 | 153 | 147 | 119 | 112 | 108 | 96 |
| | t-Butyl peroxylaurate | 159 | 148 | 142 | 118 | 112 | 108 | 98 |
| | t-Butyl peroxy isopropyl monocarbonate | 159 | 147 | 142 | 118 | 112 | 109 | 99 |
| | t-Hexyl peroxybenzoate | 160 | 148 | 143 | 119 | 113 | 110 | 99 |
| | 2,5-Dimethyl-2,5-di(benzoylperoxy)hexane | 158 | 147 | 142 | 119 | 113 | 109 | 100 |
| | t-Butyl peroxybenzoate | 167 | 155 | 149 | 125 | 118 | 115 | 104 |
| Peroxycarbonates | t-Butyl peroxy isopropyl carbonate | 159 | 147 | 142 | 118 | 112 | 109 | 99 |
| | t-Butyl peroxy-2-ethylhexyl carbonate | 166 | 153 | 147 | 121 | 115 | 111 | 100 |
| | t-Amyl peroxy isopropyl carbonate | 153 | 142 | 137 | 115 | 109 | 106 | 96 |
| | t-Amyl peroxy-2-ethylhexyl carbonate | 155 | 146 | 141 | 117 | 110 | 107 | 99 |
| Dialkyl peroxides | Dicumyl peroxide | 175 | 164 | 159 | 136 | 130 | 126 | 116 |
| | 2,5-Dimethyl-2,5-di(t-butylperoxy)hexane | 180 | 168 | 162 | 138 | 132 | 128 | 118 |
| | Di(2-t-butylperoxyisopropyl)benzene | 175 | 165 | 160 | 138 | 132 | 129 | 119 |
| | Di-t-butyl peroxide | 186 | 174 | 169 | 144 | 138 | 134 | 124 |
| | 2,5-Dimethyl-2,5-di(t-butylperoxy)hexyne-3 | 194 | 182 | 176 | 150 | 143 | 139 | 128 |
| | Di-t-amyl peroxide | 184 | 172 | 167 | 143 | 137 | 133 | 123 |
| | t-Butyl cumyl peroxide | 173 | 163 | 158 | 137 | 132 | 129 | 120 |
| | Di-t-hexyl peroxide | 177 | 165 | 160 | 136 | 130 | 126 | 116 |
| Peroxyketals | 1,1-Di(t-butylperoxy)cyclohexane | 154 | 141 | 136 | 111 | 105 | 101 | 91 |
| | 2,2-Di-(t-butylperoxy)butane | 160 | 149 | 144 | 122 | 116 | 113 | 103 |
| | n-Butyl-4,4-di(t-butylperoxy)valerate | 173 | 159 | 153 | 127 | 120 | 116 | 105 |
| | Ethyl-3,3-di(t-butylperoxy)butyrate | 175 | 163 | 158 | 134 | 128 | 124 | 114 |
| | 1,1-Di(t-amylperoxy)cyclohexane | 150 | 139 | 134 | 112 | 106 | 103 | 93 |
| | 1,1-Di(t-butylperoxy)-2-methylcyclohexane | 142 | 131 | 126 | 102 | 96 | 93 | 83 |
| | 1,1-Di(t-hexylperoxy)-3,3,5-trimethylcyclohexane | 147 | 135 | 130 | 106 | 100 | 97 | 87 |
| | 1,1-Di(t-hexylperoxy)cyclohexane | 149 | 137 | 132 | 107 | 101 | 97 | 87 |
| | 2,2-Di(4,4-di-(t-butylperoxy)cyclohexyl)propane | 154 | 142 | 137 | 114 | 108 | 105 | 95 |
| Peroxydicarbonates | Di(2-ethylhexyl) peroxydicarbonate | 91 | 82 | 78 | 59 | 54 | 52 | 44 |
| | Di-sec-butyl peroxydicarbonate | 92 | 82 | 78 | 57 | 52 | 49 | 41 |
| | Di-n-propyl peroxydicarbonate | 94 | 84 | 79 | 58 | 52 | 49 | 40 |
| | Diisopropyl peroxydicarbonate | 88 | 79 | 75 | 56 | 51 | 49 | 41 |
| | Di(4-t-butylcyclohexyl) peroxydicarbonate | 92 | 82 | 78 | 58 | 52 | 49 | 41 |
| Hydroperoxides | 1,1,3,3-Tetramethylbutyl hydroperoxide | 247 | 228 | 219 | 182 | 173 | 168 | 153 |
| | t-Butyl hydroperoxide | 261 | 242 | 233 | 196 | 187 | 182 | 167 |
| | t-Amyl hydroperoxide | 219 | 209 | 204 | 183 | 177 | 174 | 165 |
| | Cumene hydroperoxide | 254 | 235 | 226 | 188 | 179 | 173 | 158 |
| | p-Menthane hydroperoxide | 200 | 185 | 179 | 151 | 144 | 140 | 128 |
| | Diisopropylbenzene hydroperoxide | 233 | 215 | 207 | 173 | 164 | 159 | 145 |
| Diacyl peroxides | Di(3,5,5-trimethylhexanoyl) peroxide | 113 | 102 | 98 | 77 | 71 | 68 | 59 |
| | Dilauroyl peroxide | 116 | 106 | 101 | 80 | 74 | 74 | 62 |
| | Dibenzoyl peroxide | 130 | 119 | 114 | 92 | 86 | 83 | 74 |
| | Diisobutyl peroxide | 85 | 75 | 70 | 50 | 44 | 41 | 33 |
| | Disuccinic acid peroxide | 132 | 119 | 113 | 87 | 80 | 77 | 66 |
| | Di(4-methylbenzoyl) peroxide | 128 | 117 | 112 | 89 | 83 | 80 | 71 |

In the first polymerization method, the additive amount of the initiator that is added at or after a point at which the polymerization conversion rate reaches 85% is preferably 10 mass % to 25 mass %, and more preferably 10 mass % to 20 mass % when the total additive amount of the radical polymerization initiator that is added during polymerization is taken to be 100 mass %.

In the first polymerization method, when a radical polymerization initiator having a half-life of at least 1 minute and less than 60 minutes at the polymerization temperature is added into a reactor such that polymerization of monomers proceeds while gradually reducing the additive amount of the radical polymerization initiator per unit time, the addition rate of the initiator at the point at which the polymerization conversion rate reaches 85% is preferably 1/10 to ⅓ of the maximum addition rate, and more preferably 1/10 to ¼ of the maximum addition rate.

An addition rate that is at least any one of the lower limits set forth above is preferable from a viewpoint of obtaining an adequate conversion rate, whereas an addition rate that is not more than any of the upper limits set forth above is preferable from a viewpoint of inhibiting the production of polymer components that negatively affect color tone and processability.

In the first polymerization method, by charging a portion of monomer into the reactor prior to the start of polymerization and feeding a remaining portion of monomer after polymerization has been initiated through addition of the polymerization initiator, it is possible to obtain a narrower molecular weight distribution and adjust Mw/Mn and Mz/Mw to within the desired ranges because production of low molecular weight components and production of ultra-high molecular weight components are both inhibited. Moreover, it is possible to reduce the amount of N-substituted maleimide monomer remaining in a final stage of polymerization and obtain good color tone.

A ratio of the amount of initially charged monomer and the amount of monomer added after the start of polymerization is preferably 1:9 to 8:2, more preferably 2:8 to 7.5:2.5, and even more preferably 3:7 to 5:5.

It is preferable from a viewpoint of color tone enhancement that the additive amount of the methacrylic acid ester monomer, which tends to be polymerized earlier in copolymerization, is reduced in initial charging and increased in supplementary addition because this can reduce the amount of N-substituted maleimide monomer that remains in a final stage of polymerization.

The residual amount of N-substituted maleimide monomer can also be reduced through addition of a monomer such as styrene that has high alternating copolymerizability with an N-substituted maleimide monomer in polymerization.

As previously described, the second polymerization method is a method in which an initiator having a half-life of 60 minutes or more at the polymerization temperature is used as a radical polymerization initiator, and polymerization is carried out by adding a portion of the radical polymerization initiator into a reactor not more than a specific time after the start of polymerization and adding a portion of monomer at least a specific time after the start of polymerization.

In a situation in which a radical initiator having a half-life that is not significantly shorter than the polymerization time is used, a relatively high radical concentration is maintained even in a final stage of polymerization.

In this situation, variation in the ratio of residual monomer concentration relative to radical concentration during polymerization can be reduced through supplemental addition of monomer in the final stage of polymerization. Moreover, by adding a large amount of the radical initiator in an initial stage of polymerization, it is possible to maintain a low radical concentration in the final stage of polymerization when the residual monomer concentration has decreased, and thereby inhibit production of low molecular weight components during polymerization.

In the second polymerization method, the amount of the radical initiator that is added not more than 30 minutes from the start of addition of the polymerization initiator is set as 40 mass % or more of the total additive amount of the polymerization initiator, and preferably 50 mass % or more of the total additive amount of the polymerization initiator.

Moreover, the amount of monomer that is added at least 30 minutes from the start of addition of the polymerization initiator is set as 50 mass % or more of the total additive amount of monomer, and preferably 66 mass % or more of the total additive amount of monomer.

In the second polymerization method, the total additive amount of the radical initiator is preferably added not more than 4 hours from the start of addition of the polymerization initiator, more preferably not more than 3 hours from the start of addition of the polymerization initiator, and even more preferably not more than 2 hours from the start of addition of the polymerization initiator.

In the first and second production methods that may be used as methods of producing the methacrylic resin including an N-substituted maleimide structural unit (B-1) as the structural unit (B) having a cyclic structure in a main chain, two or more radical initiators may be used in combination.

In a situation in which the two or more radical initiators each have a half-life of at least 1 minute and less than 60 minutes at the polymerization temperature or each have a half-life of 60 minutes or more at the polymerization temperature, the additive amount and addition rate of radical initiator in the first and second polymerization methods may be taken to be the total additive amount and total addition rate of the two or more radical initiators.

In a case in which a radical polymerization initiator having a half-life of at least 1 minute and less than 60 minutes at the polymerization temperature and a radical polymerization initiator having a half-life of 60 minutes or more at the polymerization temperature are used in combination, the second polymerization method is adopted. Specifically, 25 mass % or more of the total additive amount of the radical polymerization initiators is added not more than 30 minutes from the start of addition of the polymerization initiators and 25 mass % or more of the total additive amount of monomer is added at least 30 minutes from the start of addition of the polymerization initiators.

No specific limitations are placed on the method by which a polymerized product is collected from the polymerization solution obtained through solution polymerization. Examples of methods that can be adopted include a method in which the polymerization solution is added into an excess of a poor solvent in which the polymerized product obtained through polymerization does not dissolve, such as a hydrocarbon solvent or an alcohol solvent, treatment (emulsifying dispersion) is subsequently performed using a homogenizer, and unreacted monomer is separated from the polymerization solution by pre-treatment such as liquid-liquid extraction or solid-liquid extraction; and a method in which the polymerization solvent and unreacted monomer are separated by a step referred to as a devolatilization step to collect the polymerized product. Of these methods, a method using a devolatilization step is preferable from a viewpoint of productivity.

The devolatilization step is a step in which volatile content such as the polymerization solvent, residual monomer, and reaction by-products are removed under heated vacuum conditions.

Examples of devices that may be used in the devolatilization step include devolatilization devices comprising a tubular heat exchanger and a devolatilization tank; thin film evaporators such as WIPRENE and EXEVA produced by Kobelco Eco-Solutions Co., Ltd., and Kontro and Diagonal-Blade Kontro produced by Hitachi, Ltd.; and vented extruders having sufficient residence time and surface area for displaying devolatilization capability.

Moreover, it is possible to adopt a devolatilization step or the like in which a devolatilization device that is a combination of two or more of these devices is used.

The treatment temperature in the devolatilization device is preferably 150° C. to 350° C., more preferably 170° C. to 300° C., and even more preferably 200° C. to 280° C. A temperature that is at least any of the lower limits set forth above can restrict residual volatile content, whereas a temperature that is not higher than any of the upper limits set forth above can inhibit coloring and decomposition of the obtained acrylic resin.

The degree of vacuum in the devolatilization device may be within a range of 10 Torr to 500 Torr, and preferably within a range of 10 Torr to 300 Torr. A degree of vacuum that is not more than any of the upper limits set forth above can restrict the residual amount of volatile content, whereas a degree of vacuum that is at least the lower limit set forth above is realistic in terms of industrial implementation.

The treatment time is selected as appropriate depending on the amount of residual volatile content and is preferably as short as possible in order to inhibit coloring or decomposition of the obtained acrylic resin.

The polymerized product collected through the devolatilization step is processed into the form of pellets through a step referred to as a pelletization step.

In the pelletization step, molten resin is extruded from a porous die as strands and is then pelletized by cold cutting pelletizing, hot cutting pelletizing, or underwater pelletizing.

In a situation in which a vented extruder is used as a devolatilization device, the devolatilization step and the pelletization step may be combined.

The following provides a detailed description of a method of producing a methacrylic resin that includes a lactone ring structural unit (B-2) as the structural unit (B) having a cyclic structure in a main chain.

The production method of the methacrylic resin including a lactone ring structural unit (B-2) in a main chain that forms the methacrylic resin shaped product according to the present embodiment is preferably solution polymerization using a solvent in order to promote a cyclization reaction. A method in which the lactone ring structure is formed through a cyclization reaction after polymerization may be adopted.

Examples of polymerization solvents that may be used include aromatic hydrocarbons such as toluene, xylene, and ethylbenzene; and ketones such as methyl ethyl ketone and methyl isobutyl ketone.

One of these solvents may be used individually, or two or more of these solvents may be used together.

Although the amount of solvent in polymerization is not specifically limited so long as conditions are provided under which polymerization proceeds and gelation is inhibited, the amount of solvent is preferably 50 parts by mass to 200 parts by mass, and more preferably 100 parts by mass to 200 parts by mass when the total amount of used monomer is taken to be 100 parts by mass.

In order to sufficiently inhibit gelation of the polymerization solution and promote a cyclization reaction after polymerization, polymerization is preferably carried out in a manner such that the concentration of produced polymer in the reaction mixture obtained after polymerization is 50 mass % or less.

The concentration is preferably controlled to 50 mass % or less through appropriate addition of the polymerization solvent to the reaction mixture. No specific limitations are placed on the method by which the polymerization solvent is appropriately added to the reaction mixture, and the polymerization solvent may be added continuously or intermittently. Moreover, the added polymerization solvent may by a single solvent or a mixed solvent of two or more types.

Although no specific limitations are placed on the polymerization temperature so long as it is a temperature at which polymerization proceeds, the polymerization temperature is preferably 50° C. to 200° C., and more preferably 80° C. to 180° C. from a viewpoint of productivity.

The polymerization time is not specifically limited so long as the target conversion rate can be achieved, but is preferably 0.5 hours to 10 hours, and more preferably 1 hour to 8 hours from a viewpoint of productivity and the like.

The polymerization conversion rate at the end of polymerization of the methacrylic resin including a lactone ring structural unit in a main chain that forms the methacrylic resin shaped product according to the present embodiment may be the same polymerization conversion rate as disclosed in relation to the production method of the methacrylic resin including an N-substituted maleimide monomer-derived structural unit.

In the polymerization reaction, polymerization may be performed with addition of a chain transfer agent as necessary.

Chain transfer agents that are commonly used in radical polymerization may be used as the chain transfer agent. For example, any of the chain transfer agents disclosed in relation to the production method of the methacrylic resin including an N-substituted maleimide monomer-derived structural unit may be used.

One of these chain transfer agents may be used individually, or two or more of these chain transfer agents may be used together.

These chain transfer agents may be added at any stage, without any specific limitations, so long as the polymerization reaction is in progress.

Although the additive amount of the chain transfer agent is not specifically limited so long as the desired degree of polymerization can be obtained under the used polymerization conditions, when the total amount of monomer used in polymerization is taken to be 100 parts by mass, the additive amount of the chain transfer agent may be 0.01 parts by mass to 1 part by mass, and is preferably 0.05 parts by mass to 0.5 parts by mass.

The dissolved oxygen concentration in the polymerization solution may be a value such as disclosed in relation to the production method of the methacrylic resin including an N-substituted maleimide monomer-derived structural unit.

In the polymerization reaction, polymerization is carried out with addition of a polymerization initiator.

Examples of polymerization initiators that may be used include, but are not specifically limited to, polymerization initiators disclosed in relation to the production method of the methacrylic resin including an N-substituted maleimide monomer-derived structural unit.

One of these polymerization initiators may be used individually, or two or more of these polymerization initiators may be used together.

Although the additive amount of the polymerization initiator is not specifically limited and may be set as appropriate depending on the combination of monomers, reaction conditions, and so forth, when the total amount of monomer used in polymerization is taken to be 100 parts by mass, the additive amount of the polymerization initiator may be 0.01 parts by mass to 1 part by mass, and is preferably 0.05 parts by mass to 0.5 parts by mass.

In polymerization of the methacrylic resin including a lactone ring structural unit that forms the methacrylic resin shaped product according to the present embodiment, variation in a ratio of the concentration of monomer and the concentration of radicals in the system during polymerization can be reduced, production of low molecular weight components in a final stage of polymerization can be inhibited, and coloring and shaping processability can be enhanced by adding polymerization initiator and, as necessary, monomer partway through polymerization and controlling the additive amount thereof.

In a first polymerization method, an initiator having a half-life of at least 1 minute and less than 60 minutes at the polymerization temperature is used as a radical polymerization initiator in polymerization by a batch process or a semi-batch process, and the radical polymerization initiator is added into a reactor such that polymerization of monomers proceeds while gradually reducing the additive amount of the radical polymerization initiator per unit time.

In a second polymerization method, an initiator having a half-life of 60 minutes or more at the polymerization temperature is used as a radical polymerization initiator in polymerization by a batch process or a semi-batch process, and polymerization is carried out by adding a portion of the radical polymerization initiator into a reactor not more than a specific time after the start of polymerization, and adding a portion of monomer at least a specific time after the start of polymerization.

The following describes these polymerization methods.

As described above, the first polymerization method is a method in which an initiator having a half-life of at least 1 minute and less than 60 minutes at the polymerization temperature is used as a radical polymerization initiator, and the radical polymerization initiator is added into a reactor such as to cause polymerization of monomers while gradually reducing the additive amount of the radical polymerization initiator per unit time.

The radical polymerization initiator having a half-life of at least 1 minute and less than 60 minutes at the polymerization temperature is, in other words, a radical polymerization initiator for which the polymerization temperature is higher than the one-hour half-life temperature thereof but not higher than the one-minute half-life temperature thereof.

It is preferable that the initiator has a half-life of 1 minute or more at the polymerization temperature because this enables decomposition of the initiator and initiation of polymerization to occur after the initiator has been added into the polymerization reactor and sufficiently mixed with the contents thereof. Moreover, by adding an initiator having a half-life that is significantly shorter than the polymerization time during polymerization, it is possible to maintain low variation in the ratio of residual monomer concentration relative to radical concentration in the reaction system, maintain a low radical concentration in a final stage of polymerization in which the residual monomer concentration has decreased, and thereby inhibit production of low molecular weight components during polymerization.

The half-life of the radical polymerization initiator at the polymerization temperature is preferably at least 3 minutes and less than 60 minutes, and more preferably at least 5 minutes and less than 60 minutes.

The definition and calculation method of the half-life temperature and examples of half-life temperatures of radical initiators are the same as disclosed in relation to the production method of the methacrylic resin including an N-substituted maleimide monomer-derived structural unit.

In the first polymerization method, the additive amount of the initiator that is added at or after a point at which the polymerization conversion rate reaches 85% is preferably 10 mass % to 25 mass %, and more preferably 10 mass % to 20 mass % when the total additive amount of the radical polymerization initiator that is added during polymerization is taken to be 100 mass %.

When a radical polymerization initiator having a half-life of at least 1 minute and less than 60 minutes at the polymerization temperature is added into a reactor such that polymerization of monomers proceeds while gradually reducing the additive amount of the radical polymerization initiator per unit time in the first polymerization method, the addition rate of the initiator at the point at which the polymerization conversion rate reaches 85% is preferably 1/10 to ⅓ of the maximum addition rate, and more preferably 1/10 to ¼ of the maximum addition rate.

An addition rate that is at least any of the lower limits set forth above is preferable from a viewpoint of obtaining an adequate conversion rate, whereas an addition rate that is not more than any of the upper limits set forth above is preferable from a viewpoint of inhibiting the production of polymer components that negatively affect color tone and processability.

In the first polymerization method, by charging a portion of monomer into the reactor before initiating polymerization and feeding a remaining portion of monomer after initiating polymerization through addition of the polymerization initiator, it is possible to obtain a narrower molecular weight distribution and adjust Mw/Mn and Mz/Mw to within the desired ranges because production of low molecular weight components and production of ultra-high molecular weight components are both inhibited. Moreover, by uniformly introducing hydroxy group-containing acrylic acid-based monomer into molecules while avoiding consecutive introduction thereof to as great an extent as possible, it is possible to increase the cyclization rate in molecules, inhibit gelation, and inhibit deterioration of color tone. Therefore, it is preferable to perform supplemental addition of monomer after the start of polymerization.

A ratio of the amount of initially charged monomer and the amount of monomer added after the start of polymerization is preferably 1:9 to 8:2, more preferably 2:8 to 7.5:2.5, and even more preferably 3:7 to 5:5.

As previously described, the second polymerization method is a method in which an initiator having a half-life of 60 minutes or more at the polymerization temperature is used as a radical polymerization initiator, and polymerization is carried out by adding a portion of the radical polymerization initiator into a reactor not more than a specific time after the start of polymerization and adding a portion of monomer at least a specific time after the start of polymerization.

In a situation in which a radical initiator having a half-life that is not significantly shorter than the polymerization time is used, a relatively high radical concentration is maintained even in a final stage of polymerization.

In this situation, variation in the ratio of residual monomer concentration relative to radical concentration during polymerization can be reduced through supplemental addition of monomer in the final stage of polymerization. Moreover, by adding a large amount of the radical initiator in an initial stage of polymerization, it is possible to maintain a low radical concentration in the final stage of polymerization when the residual monomer concentration has decreased, and thereby inhibit production of low molecular weight components during polymerization.

In the second polymerization method, the amount of the radical initiator that is added not more than 30 minutes from the start of addition of the polymerization initiator is set as 40 mass % or more of the total additive amount of the polymerization initiator, and preferably 50 mass % or more of the total additive amount of the polymerization initiator.

Moreover, the amount of monomer that is added at least 30 minutes from the start of addition of the polymerization initiator is set as 50 mass % or more of the total additive amount of monomer, and preferably 66 mass % or more of the total additive amount of monomer.

In the second polymerization method, the total additive amount of the radical initiator is preferably added not more than 4 hours from the start of addition of the polymerization initiator, more preferably not more than 3 hours from the start of addition of the polymerization initiator, and even more preferably not more than 2 hours from the start of addition of the polymerization initiator.

In the first and second production methods that may be used as methods of producing the methacrylic resin including a lactone ring structural unit (B-2) as the structural unit (B) having a cyclic structure in a main chain, two or more radical initiators may be used in combination.

In a situation in which the two or more radical initiators each have a half-life of at least 1 minute and less than 60 minutes at the polymerization temperature or each have a half-life of 60 minutes or more at the polymerization temperature, the additive amount and addition rate of radical initiator in the first and second polymerization methods may be taken to be the total additive amount and total addition rate of the two or more radical initiators.

In a case in which a radical polymerization initiator having a half-life of at least 1 minute and less than 60 minutes at the polymerization temperature and a radical polymerization initiator having a half-life of 60 minutes or more at the polymerization temperature are used in combination, the second polymerization method is adopted. Specifically, 40 mass % or more of the total additive amount of the radical polymerization initiators is added not more than 30 minutes from the start of addition of the polymerization initiators and 50 mass % or more of the total additive amount of monomer is added at least 30 minutes from the start of addition of the polymerization initiators.

The methacrylic resin including a lactone ring structural unit that forms the methacrylic resin shaped product according to the present embodiment can be obtained by carrying out a cyclization reaction after the polymerization reaction ends. Therefore, the polymerization reaction solution is preferably subjected to a lactone cyclization reaction in a solvent-containing state without removing the polymerization solvent.

Heat treatment of the copolymer obtained through polymerization causes a hydroxy group and an ester group present in the molecular chain of the copolymer to undergo a cyclocondensation reaction to form a lactone ring structure.

Note that a reactor including a vacuum device or a devolatilization device, an extruder including a devolatilization device, or the like may be used in order to remove alcohol that may be obtained as a by-product of cyclocondensation in heat treatment for lactone ring structure formation.

In lactone ring structure formation, heat treatment may be performed using a cyclocondensation catalyst as necessary to promote the cyclocondensation reaction.

Specific examples of cyclocondensation catalysts that may be used include monoalkyl, dialkyl, and trialkyl esters of phosphorus acid such as methyl phosphite, ethyl phosphite, phenyl phosphite, dimethyl phosphite, diethyl phosphite, diphenyl phosphite, trimethyl phosphite, and triethyl phosphite; and monoalkyl, dialkyl, and trialkyl esters of phosphoric acid such as methyl phosphate, ethyl phosphate, 2-ethylhexyl phosphate, octyl phosphate, isodecyl phosphate, lauryl phosphate, stearyl phosphate, isostearyl phosphate, dimethyl phosphate, diethyl phosphate, di-2-ethylhexyl phosphate, diisodecyl phosphate, dilauryl phosphate, distearyl phosphate, diisostearyl phosphate, trimethyl phosphate, triethyl phosphate, triisodecyl phosphate, trilauryl phosphate, tristearyl phosphate, and triisostearyl phosphate.

One of these cyclocondensation catalysts may be used individually, or two or more of these cyclocondensation catalysts may be used together.

Although the amount of cyclocondensation catalyst that is used is not specifically limited, the amount of the cyclocondensation catalyst relative to 100 parts by mass of the methacrylic resin is, for example, preferably 0.01 parts by mass to 3 parts by mass, and more preferably 0.05 parts by mass to 1 part by mass.

The rate of reaction in the cyclocondensation reaction may not be sufficiently improved if the amount of catalyst that is used is less than 0.01 parts by mass. Conversely, coloring of the resultant polymer or crosslinking of the polymer that makes melt shaping difficult may occur if the amount of catalyst that is used is more than 3 parts by mass.

The timing of addition of the cyclocondensation catalyst is not specifically limited. For example, the cyclocondensation catalyst may be added in an initial stage of the cyclocondensation reaction, may be added partway through the reaction, or may be added both in the initial stage and partway through the reaction.

In a situation in which the cyclocondensation reaction is carried out in the presence of a solvent, devolatilization is preferably carried out concurrently with the reaction.

Although no specific limitations are placed on the device used in a situation in which the cyclocondensation reaction and a devolatilization step are carried out concurrently, it is preferable to use a devolatilization device comprising a heat exchanger and a devolatilization tank, a vented extruder, or an apparatus in which a devolatilization device and an extruder are arranged in series, and more preferable to use a vented twin screw extruder.

The vented twin screw extruder is preferably a vented extruder having a plurality of vent ports.

In a situation in which a vented extruder is used, the reaction treatment temperature is preferably 150° C. to 350° C., and more preferably 200° C. to 300° C. Cyclocondensation reaction may be inadequate and residual volatile content may be excessive if the reaction treatment temperature is lower than 150° C. Conversely, coloring or decomposition of the resultant polymer may occur if the reaction treatment temperature is higher than 350° C.

In a situation in which a vented extruder is used, the degree of vacuum therein is preferably 10 Torr to 500 Torr, and more preferably 10 Torr to 300 Torr. Volatile content tends to remain if the degree of vacuum is higher than 500 Torr. Conversely, industrial implementation becomes difficult if the degree of vacuum is lower than 10 Torr.

When a cyclocondensation reaction is performed as described above, an alkaline earth metal and/or amphoteric metal salt of an organic acid is preferably added in pelletization to deactivate residual cyclocondensation catalyst.

Examples of the alkaline earth metal and/or amphoteric metal salt of an organic acid include calcium acetyl acetate, calcium stearate, zinc acetate, zinc octanoate, and zinc 2-ethylhexanoate.

After the cyclocondensation reaction step is completed, the methacrylic resin is melted and extruded as strands from an extruder equipped with a porous die, and is then processed into the form of pellets by cold cutting pelletizing, hot cutting pelletizing, or underwater pelletizing.

Lactonization for forming the lactone ring structural unit may be carried out after resin production and before resin composition production (described below) or may be carried out in conjunction with melt-kneading of the resin and components other than the resin during resin composition production.

The methacrylic resin forming the methacrylic resin shaped product according to the present embodiment preferably includes at least one cyclic structural unit selected from the group consisting of an N-substituted maleimide monomer-derived structural unit and a lactone ring structural unit, with inclusion of an N-substituted maleimide monomer-derived structural unit being particularly preferable because this enables simple control of optical properties such as photoelastic coefficient to a high degree even without blending with another thermoplastic resin.

(Methacrylic Resin Composition)

A methacrylic resin composition forming the methacrylic resin shaped product according to the present embodiment may include a methacrylic resin composition that contains the methacrylic resin according to the present embodiment set forth above. In addition to the methacrylic resin according to the present embodiment set forth above, the methacrylic resin composition may optionally further contain additives, thermoplastic resins other than methacrylic resin, rubbery polymers, and so forth.

—Additives—

The methacrylic resin composition forming the methacrylic resin shaped product according to the present embodiment may contain various additives to the extent that the effects disclosed herein are not significantly lost.

Examples of additives that may be used include, but are not specifically limited to, antioxidants, light stabilizers such as hindered amine light stabilizers, ultraviolet absorbers, release agents, other thermoplastic resins, paraffinic process oils, naphthenic process oils, aromatic process oils, paraffin, organic polysiloxanes, mineral oils, other softeners and plasticizers, flame retardants, antistatic agents, organic fibers, inorganic fillers such as pigments (for example, iron oxide), reinforcers such as glass fiber, carbon fiber, and metal whisker, colorants, organophosphorus compounds such as phosphorus acid esters, phosphonites, and phosphoric acid esters, other additives, and mixtures of any of the preceding examples.

——Antioxidant——

It is preferable that the methacrylic resin composition forming the methacrylic resin shaped product according to the present embodiment contains an antioxidant to inhibit degradation and coloring during shaping processing or use.

Examples of antioxidants that may be used include, but are not limited to, hindered phenol antioxidants, phosphoric antioxidants, and sulfuric antioxidants. The methacrylic resin according to the present embodiment is suitable for use in various applications such as melt-extrusion, injection molding, and film shaping applications. The heat history imparted in processing depends on the processing method and may take various forms such as tens of seconds in the case of an extruder to tens of minutes to several hours in the case of shaping processing of a thick product or shaping of a sheet.

In a case in which a long heat history is imparted, it is necessary to increase the additive amount of thermal stabilizer in order to obtain the desired thermal stability. From a viewpoint of inhibiting thermal stabilizer bleed-out and preventing adhesion of a film to a roller in film production, it is preferable to use a plurality of thermal stabilizers together. For example, it is preferable to use a hindered phenol antioxidant together with at least one selected from a phosphoric antioxidant and a sulfuric antioxidant.

One of these antioxidants may be used, or two or more of these antioxidants may be used together.

Examples of hindered phenol antioxidants that may be used include, but are not limited to, pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, 3,3′,3″,5,5′,5″-hexa-tert-butyl-a,a′,a″-(mesitylene-2,4,6-triyl)tri-p-cresol, 4,6-bis(octylthiomethyl)-o-cresol, 4,6-bis(dodecylthiomethyl)-o-cresol, ethylenebis(oxyethylene) bis[3-(5-tert-butyl-4-hydroxy-m-tolyl)propionate], hexamethylene bis[3-(3,5-di-tert-butyl-4-hydroxyphenyl)propionate], 1,3,5-tris(3,5-di-tert-butyl-4-hydroxybenzyl)-1,3,5-triazine-2,4,6(1H,3H,5H)-trione, 1,3,5-tris[(4-tert-butyl-3-hydroxy-2,6-xylene)methyl]-1,3,5-triazine-2,4,6(1H, 3H,5H)-trione, 2,6-di-tert-butyl-4-(4,6-bis(octylthio)-1,3,5-triazin-2-ylamine)phenol, 2-[1-(2-hydroxy-3,5-di-tert-pentylphenyl)ethyl]-4,6-di-tert-pentylphenyl acrylate, and 2-tert-butyl-4-methyl-6-(2-hydroxy-3-tert-butyl-5-methylbenzyl)phenyl acrylate.

In particular, pentaerythritol tetrakis[3-(3,5-di-tert-butyl-4-hydroxyphenyl)propionate], octadecyl-3-(3,5-di-t-butyl-4-hydroxyphenyl)propionate, and 2-[1-(2-hydroxy-3,5-di-tert-pentylphenyl)ethyl]-4,6-di-tert-pentylphenyl acrylate are preferable.

A commercially available phenolic antioxidant may be used as a hindered phenol antioxidant serving as the antioxidant. Examples of such commercially available phenolic antioxidants include, but are not limited to, Irganox 1010 (pentaerythritol tetrakis[3-(3,5-di-t-butyl-4-hydroxyphenyl)propionate]; produced by BASF), Irganox 1076 (octadecyl-3-(3,5-di-t-butyl-4-hydroxyphenyl)propionate; produced by BASF), Irganox 1330 (3,3′,3″,5,5′,5″-hexa-t-butyl-a,a′,a″-(mesitylene-2,4,6-triyl)tri-p-cresol; produced by BASF), Irganox 3114 (1,3,5-tris(3,5-di-t-butyl-4-hydroxybenzyl)-1,3,5-triazine-2,4,6(1H,3H,5H)-trione; produced by BASF), Irganox 3125 (produced by BASF), ADK STAB AO-60 (pentaerythritol tetrakis[3-(3,5-di-t-butyl-4-hydroxyphenyl)propionate]; produced by Adeka Corporation), ADK STAB AO-80 (3,9-bis {2-[3-(3-t-butyl-4-hydroxy-5-methylphenyl)propionyloxy]-1,1-dimeth ylethyl}-2,4,8,10-tetraoxaspiro[5.5]undecane; produced by Adeka Corporation), Sumilizer BHT (produced by Sumitomo Chemical Co., Ltd.), Cyanox 1790 (produced by Cytec Solvay Group), Sumilizer GA-80 (produced by Sumitomo Chemical Co., Ltd.), Sumilizer GS (2-[1-(2-hydroxy-3,5-di-tert-pentylphenyl)ethyl]-4,6-di-tert-pentylphenyl acrylate; produced by Sumitomo Chemical Co., Ltd.), Sumilizer GM (2-tert-butyl-4-methyl-6-(2-hydroxy-3-tert-butyl-5-methylbenzyl)phenyl acrylate; produced by Sumitomo Chemical Co., Ltd.), and vitamin E (produced by Eisai Co., Ltd.).

Of these commercially available phenolic antioxidants, Irganox 1010, ADK STAB AO-60, ADK STAB AO-80, Irganox 1076, Sumilizer GS, and the like are preferable in terms of thermal stability imparting effect in the resin.

One of these phenolic antioxidants may be used individually, or two or more of these phenolic antioxidants may be used together.

Examples of phosphoric antioxidants that may be used as the antioxidant include, but are not limited to, tris(2,4-di-t-butylphenyl) phosphite, phosphorus acid bis(2,4-bis(1,1-dimethylethyl)-6-methylphenyl)ethyl ester, tetrakis(2,4-di-t-butylphenyl)(1,1-biphenyl)-4,4′-diyl bisphosphonite, bis(2,4-di-t-butylphenyl)pentaerythritol diphosphite, bis(2,6-di-t-butyl-4-methylphenyl)pentaerythritol diphosphite, bis(2,4-dicumylphenyl)pentaerythritol diphosphite, tetrakis(2,4-t-butylphenyl)(1,1-biphenyl)-4,4′-diyl bisphosphonite, di-t-butyl-m-cresyl phosphonite, and 4-[3-[(2,4,8,10-tetra-tert-butyldibenzo[d,f][1,3,2]dioxaphosphepin)-6-yloxy]propyl]-2-methyl-6-tert-butylphenol.

A commercially available phosphoric antioxidant may be used as the phosphoric antioxidant. Examples of such commercially available phosphoric antioxidants include, but are not limited to, Irgafos 168 (tris(2,4-di-t-butylphenyl) phosphite; produced by BASF), Irgafos 12 (tris[2-[[2,4,8,10-tetra-t-butyldibenzo[d,f][1,3,2]dioxaphosphepin-6-yl]oxy]ethyl]amine; produced by BASF), Irgafos 38 (phosphorus acid bis(2,4-bis(1,1-dimethylethyl)-6-methylphenyl)ethyl ester; produced by BASF), ADK STAB 329K (produced by Adeka Corporation), ADK STAB PEP-36 (produced by Adeka Corporation), ADK STAB PEP-36A (produced by Adeka Corporation), ADK STAB PEP-8 (produced by Adeka Corporation), ADK STAB HP-10 (produced by Adeka Corporation), ADK STAB 2112 (produced by Adeka Corporation), ADK STAB 1178 (produced by Adeka Corporation), ADK STAB 1500 (produced by Adeka Corporation), Sandstab P-EPQ (produced by Clariant), Weston 618 (produced by GE), Weston 619G (produced by GE), Ultranox 626 (produced by GE), Sumilizer GP (4-[3-[(2,4,8,10-tetra-tert-butyldibenzo[d,f][1,3,2]dioxaphosphepin)-6-yloxy]propyl]-2-methyl-6-tert-butylphenol; produced by Sumitomo Chemical Co., Ltd.), and HCA (9,10-dihydro-9-oxa-10-phosphaphenanthrene-10-oxide; produced by Sanko Co., Ltd.).

Of these commercially available phosphoric antioxidants, Irgafos 168, ADK STAB PEP-36, ADK STAB PEP-36A, ADK STAB HP-10, and ADK STAB 1178 are preferable, and ADK STAB PEP-36A and ADK STAB PEP-36 are particularly preferable from a viewpoint of thermal stability imparting effect in the resin and combined effect with various antioxidants.

One of these phosphoric antioxidants may be used individually, or two or more of these phosphoric antioxidants may be used together.

Examples of sulfuric antioxidants that may be used as the antioxidant include, but are not limited to, 2,4-bis(dodecylthiomethyl)-6-methylphenol (Irganox 1726 produced by BASF), 2,4-bis(octylthiomethyl)-6-methylphenol (Irganox 1520L produced by BASF), 2,2-bis {[3-(dodecylthio)-1-oxopropoxy]methyl}propan-1,3-diyl bis[3-(dodecylthio)propionate] (ADK STAB AO-412S produced by Adeka Corporation), 2,2-bis {[3-(dodecylthio)-1-oxopropoxy]methyl}propan-1,3-diyl bis[3-(dodecylthio)propionate] (KEMINOX PLS produced by Chemipro Kasei Kaisha, Ltd.), and di(tridecyl)-3,3′-thiodipropionate (AO-503 produced by Adeka Corporation).

Of these commercially available sulfuric antioxidants, ADK STAB AO-412S and KEMINOX PLS are preferable from a viewpoint of thermal stability imparting effect in the resin and combined effect with various antioxidants, and from a viewpoint of handleability.

One of these sulfuric antioxidants may be used individually, or two or more of these sulfuric antioxidants may be used together.

Although the content of the antioxidant may be any amount that enables an effect of thermal stability improvement, excessively high antioxidant content may lead to problems such as bleed-out during processing. Accordingly, the content of the antioxidant relative to 100 parts by mass of the methacrylic resin is preferably 5 parts by mass or less, more preferably 3 parts by mass or less, even more preferably 1 part by mass or less, further preferably 0.8 parts by mass or less, even further preferably 0.01 parts by mass to 0.8 parts by mass, and particularly preferably 0.01 parts by mass to 0.5 parts by mass.

Although no specific limitations are placed on the timing of addition of the antioxidant, a method in which the antioxidant is added to a monomer solution before polymerization and polymerization is subsequently initiated, a method in which the antioxidant is added to and mixed with a polymer solution obtained after polymerization, and is then subjected to a devolatilization step, a method in which the antioxidant is added to and mixed with molten polymer after devolatilization and then pelletization is performed, or a method in which the antioxidant is added to and mixed with devolatilized and pelletized pellets when these pellets are re-melted and extruded may, for example, be adopted. Of these methods, it is preferable that the antioxidant is added to and mixed with a polymer solution obtained after polymerization, before a devolatilization step is performed, and that a devolatilization step is subsequently performed from a viewpoint of preventing thermal degradation and coloring in the devolatilization step.

——Hindered Amine Light Stabilizer——

The methacrylic resin composition forming the methacrylic resin shaped product according to the present embodiment may contain a hindered amine light stabilizer.

The hindered amine light stabilizer is preferably a compound including three or more cyclic structures but is not specifically limited thereto.

At least one cyclic structure selected from the group consisting of an aromatic ring, an aliphatic ring, an aromatic heterocycle, and a non-aromatic heterocycle is preferable. Moreover, in the case of a single compound including two or more cyclic structures, these cyclic structures may be the same or different.

Specific examples of hindered amine light stabilizers that may be used include, but are not limited to, bis(1,2,2,6,6-pentamethyl-4-piperidyl) [[3,5-bis(1,1-dimethyl ethyl)-4-hydroxyphenyl]methyl]butylmalonate, a mixture of bis(1,2,2,6,6-pentamethyl-4-piperidyl) sebacate and methyl 1,2,2,6,6-pentamethyl-4-piperidyl sebacate, bis(2,2,6,6-tetramethyl-4-piperidyl) sebacate, N,N′-bis(2,2,6,6-tetramethyl-4-piperidyl)-N,N′-diformylhexamethylenediamine, a polycondensate of dibutylamine/1,3,5-triazine/N,N′-bis(2,2,6,6-tetramethyl-4-piperidiyl)-1,6-hexamethylenediamine and N-(2,2,6,6-tetramethyl-4-piperidiyl)butylamine, poly[{6-(1,1,3,3-tetramethylbutyl)amino-1,3,5-triazin-2,4-diyl}{(2,2,6,6-tetra methyl-4-piperidyl)imino}hexamethylene{(2,2,6,6-tetramethyl-4-piperidyl)imino}], tetrakis(1,2,2,6,6-pentamethyl-4-piperidyl)butane-1,2,3,4-tetracarboxylate, tetrakis(2,2,6,6-tetramethyl-4-piperidyl)butane-1,2,3,4-tetracarboxylate, a reaction product of 1,2,2,6,6-pentamethyl-4-piperidinol and β,β,β′,β′-tetramethyl-2,4,8,10-tetraoxaspiro[5.5]undecane-3,9-diethanol, a reaction product of 2,2,6,6-tetramethyl-4-piperidinol and β,β,β′,β′-tetramethyl-2,4,8,10-tetraoxaspiro[5.5]undecane-3,9-diethanol, bis(1-undecanoxy-2,2,6,6-tetramethylpiperidin-4-yl)carbonate, 1,2,2,6,6-pentamethyl-4-piperidyl methacrylate, and 2,2,6,6-tetramethyl-4-piperidyl methacrylate.

Of these examples, bis(1,2,2,6,6-pentamethyl-4-piperidyl) [[3,5-bis(1,1-dimethylethyl)-4-hydroxyphenyl]methyl]butylmalonate, a polycondensate of dibutylamine/1,3,5-triazine/N,N′-bis(2,2,6,6-tetramethyl-4-piperidiyl)-1,6-hexamethylenediamine and N-(2,2,6,6-tetramethyl-4-piperidiyl)butylamine, poly[{6-(1,1,3,3-tetramethylbutyl)amino-1,3,5-triazin-2,4-diyl}{(2,2,6,6-tetra methyl-4-piperidyl)imino}hexamethylene{(2,2,6,6-tetramethyl-4-piperidyl)imino}], a reaction product of 1,2,2,6,6-pentamethyl-4-piperidinol and β,β,β′,β′-tetramethyl-2,4,8,10-tetraoxaspiro[5.5]undecane-3,9-diethanol, and a reaction product of 2,2,6,6-tetramethyl-4-piperidinol and β,β,β′,β′-tetramethyl-2,4,8,10-tetraoxaspiro[5.5]undecane-3,9-diethanol, which include three or more cyclic structures, are preferable.

Although the content of the hindered amine light stabilizer may be any amount that enables an effect of light stability improvement, excessively high hindered amine light stabilizer content may lead to problems such as bleed-out during processing. Accordingly, the content of the hindered amine light stabilizer relative to 100 parts by mass of the methacrylic resin is preferably 5 parts by mass or less, more preferably 3 parts by mass or less, even more preferably 1 part by mass or less, further preferably 0.8 parts by mass or less, even further preferably 0.01 parts by mass to 0.8 parts by mass, and particularly preferably 0.01 parts by mass to 0.5 parts by mass.

——Ultraviolet Absorber——

The methacrylic resin composition forming the methacrylic resin shaped product according to the present embodiment may contain an ultraviolet absorber.

Although no specific limitations are placed on ultraviolet absorbers that may be used, an ultraviolet absorber having a maximum absorption wavelength in a range of 280 nm to 380 nm is preferable. Examples of ultraviolet absorbers that may be used include benzotriazole compounds, benzotriazine compounds, benzophenone compounds, oxybenzophenone compounds, benzoate compounds, phenolic compounds, oxazole compounds, cyanoacrylate compounds, and benzoxazinone compounds.

Examples of benzotriazole compounds include 2,2′-methylenebis[4-(1,1,3,3-tetramethylbutyl)-6-(2H-benzotriazol-2-yl)phenol], 2-(3,5-di-tert-butyl-2-hydroxyphenyl)-5-chlorobenzotriazole, 2-(2H-benzotriazol-2-yl)-p-cresol, 2-(2H-benzotriazol-2-yl)-4,6-bis(1-methyl-1-phenylethyl)phenol, 2-benzotriazol-2-yl-4,6-di-tert-butylphenol, 2-[5-chloro(2H)-benzotriazol-2-yl]-4-methyl-6-t-butylphenol, 2-(2H-benzotriazol-2-yl)-4,6-di-t-butylphenol, 2-(2H-benzotriazol-2-yl)-4-(1,1,3,3-tetramethylbutyl)phenol, 2-(2H-benzotriazol-2-yl)-4-methyl-6-(3,4,5,6-tetrahydrophthalimidylmethyl)phenol, methyl 3-(3-(2H-benzotriazol-2-yl)-5-t-butyl-4-hydroxyphenyl)propionate/polyethylene glycol 300 reaction product, 2-(2H-benzotriazol-2-yl)-6-(linear/branched dodecyl)-4-methylphenol, 2-(5-methyl-2-hydroxyphenyl)benzotriazole, 2-[2-hydroxy-3,5-bis(α,α-dimethylbenzyl)phenyl]-2H-benzotriazole, and 3-(2H-benzotriazol-2-yl)-5-(1,1-dimethylethyl)-4-hydroxy-C7-9 branched/linear alkyl esters.

Of these benzotriazole compounds, benzotriazole compounds having a molecular weight of 400 or more are preferable. Examples of such benzotriazole compounds that are commercially available products include Kemisorb® 2792 (Kemisorb is a registered trademark in Japan, other countries, or both; produced by Chemipro Kasei Kaisha, Ltd.), ADK STAB® LA31 (ADK STAB is a registered trademark in Japan, other countries, or both; produced by Adeka Corporation), and TINUVIN® 234 (TINUVIN is a registered trademark in Japan, other countries, or both; produced by BASF).

Examples of benzotriazine compounds include 2-mono(hydroxyphenyl)-1,3,5-triazine compounds, 2,4-bis(hydroxyphenyl)-1,3,5-triazine compounds, and 2,4,6-tris(hydroxyphenyl)-1,3,5-triazine compounds. Specific examples include 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl-(2-hydroxy-4-propoxyphenyl)-1,3,5-triazine, 2,4-diphenyl-(2-hydroxy-4-butoxyphenyl)-1,3,5-triazine, 2,4-diphenyl-6-(2-hydroxy-4-butoxyphenyl)-1,3,5-triazine, 2,4-diphenyl-6-(2-hydroxy-4-hexyloxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazine, 2,4-diphenyl-6-(2-hydroxy-4-benzyloxyphenyl)-1,3,5-triazine, 2,4-diphenyl-6-(2-hydroxy-4-butoxyethoxy)-1,3,5-triazine, 2,4-bis(2-hydroxy-4-butoxyphenyl)-6-(2,4-dibutoxyphenyl)-1,3,5-triazine, 2,4,6-tris(2-hydroxy-4-methoxyphenyl)-1,3,5-triazine, 2,4,6-tris(2-hydroxy-4-ethoxyphenyl)-1,3,5-triazine, 2,4,6-tris(2-hydroxy-4-propoxyphenyl)-1,3,5-triazine, 2,4,6-tris(2-hydroxy-4-butoxyphenyl)-1,3,5-triazine, 2,4,6-tris(2-hydroxy-4-hexyloxyphenyl)-1,3,5-triazine, 2,4,6-tris(2-hydroxy-4-octyloxyphenyl)-1,3,5-triazine, 2,4,6-tris(2-hydroxy-4-dodecyloxyphenyl)-1,3,5-triazine, 2,4,6-tris(2-hydroxy-4-benzyloxyphenyl)-1,3,5-triazine, 2,4,6-tris(2-hydroxy-4-ethoxyethoxyphenyl)-1,3,5-triazine, 2,4,6-tris(2-hydroxy-4-butoxyethoxyphenyl)-1,3,5-triazine, 2,4,6-tris(2-hydroxy-4-propoxyethoxyphenyl)-1,3,5-triazine, 2,4,6-tris(2-hydroxy-4-methoxycarbonylpropyloxyphenyl)-1,3,5-triazine, 2,4,6-tris(2-hydroxy-4-ethoxycarbonylethyl oxyphenyl)-1,3,5-triazine, 2,4,6-tris(2-hydroxy-4-(1-(2-ethoxyhexyloxy)-1-oxopropan-2-yloxy)phenyl)-1,3,5-triazine, 2,4,6-tris(2-hydroxy-3-methyl-4-methoxyphenyl)-1,3,5-triazine, 2,4,6-tris(2-hydroxy-3-methyl-4-ethoxyphenyl)-1,3,5-triazine, 2,4,6-tris(2-hydroxy-3-methyl-4-propoxyphenyl)-1,3,5-triazine, 2,4,6-tris(2-hydroxy-3-methyl-4-butoxyphenyl)-1,3,5-triazine, 2,4,6-tris(2-hydroxy-3-methyl-4-hexyloxyphenyl)-1,3,5-triazine, 2,4,6-tris(2-hydroxy-3-methyl-4-octyloxyphenyl)-1,3,5-triazine, 2,4,6-tris(2-hydroxy-3-methyl-4-dodecyloxyphenyl)-1,3,5-triazine, 2,4,6-tris(2-hydroxy-3-methyl-4-benzyloxyphenyl)-1,3,5-triazine, 2,4,6-tris(2-hydroxy-3-methyl-4-ethoxyethoxyphenyl)-1,3,5-triazine, 2,4,6-tris(2-hydroxy-3-methyl-4-butoxyethoxyphenyl)-1,3,5-triazine, 2,4,6-tris(2-hydroxy-3-methyl-4-propoxyethoxyphenyl)-1,3,5-triazine, 2,4,6-tris(2-hydroxy-3-methyl-4-methoxycarbonylpropyloxyphenyl)-1,3,5-triazine, 2,4,6-tris(2-hydroxy-3-methyl-4-ethoxycarbonylethyl oxyphenyl)-1,3,5-triazin e, and 2,4,6-tris(2-hydroxy-3-methyl-4-(1-(2-ethoxyhexyloxy)-1-oxopropan-2-yloxy)phenyl)-1,3,5-triazine.

Commercially available products such as Kemisorb 102 (produced by Chemipro Kasei Kaisha, Ltd.), LA-F70 (produced by Adeka Corporation), LA-46 (produced by Adeka Corporation), TINUVIN 405 (produced by BASF), TINUVIN 460 (produced by BASF), TINUVIN 479 (produced by BASF), and TINUVIN 1577FF (produced by BASF) may be used as these benzotriazine compounds.

Of these benzotriazine compounds, an ultraviolet absorber having a 2,4-bis(2,4-dimethylphenyl)-6-[2-hydroxy-4-(3-alkyloxy-2-hydroxypropyloxy)-5-α-cumylphenyl]-s-triazine framework (“alkyloxy” refers to a long chain alkyloxy group such as an octyloxy, nonyloxy, or decyloxy group) is more preferable in terms of having high acrylic resin compatibility and excellent ultraviolet absorption properties.

Particularly from a viewpoint of resin compatibility and volatility during heating, the ultraviolet absorber is preferably a benzotriazine compound or a benzotriazole compound having a molecular weight of 400 or more, and from a viewpoint of inhibiting decomposition of the ultraviolet absorber under heating during extrusion processing, the ultraviolet absorber is particularly preferably a benzotriazine compound.

The melting point (Tm) of the ultraviolet absorber is preferably 80° C. or higher, more preferably 100° C. or higher, even more preferably 130° C. or higher, and further preferably 160° C. or higher.

The weight reduction rate of the ultraviolet absorber under heating from 23° C. to 260° C. at a rate of 20° C./min is preferably 50% or less, more preferably 30% or less, even more preferably 15% or less, further preferably 10% or less, and even further preferably 5% or less.

One of these ultraviolet absorbers may be used individually, or two or more of these ultraviolet absorbers may be used together. The combined use of two ultraviolet absorbers having different structures enables ultraviolet absorption over a wide wavelength region.

Although the content of the ultraviolet absorber is not specifically limited so long as the effects disclosed herein can be displayed without impairing heat resistance, damp heat resistance, thermal stability, and shaping processability, the content relative to 100 parts by mass of the methacrylic resin is preferably 0.1 parts by mass to 5 parts by mass, more preferably 0.2 parts by mass to 4 parts by mass, even more preferably 0.25 parts by mass to 3 parts by mass, and further preferably 0.3 parts by mass to 3 parts by mass. When the content of the ultraviolet absorber is within any of the ranges set forth above, an excellent balance of ultraviolet absorption performance, shaping properties, and so forth can be obtained.

——Release Agent——

The methacrylic resin composition forming the methacrylic resin shaped product according to the present embodiment may contain a release agent. Examples of release agents that may be used include, but are not limited to, fatty acid esters, fatty acid amides, fatty acid metal salts, hydrocarbon lubricants, alcohol lubricants, polyalkylene glycols, carboxylic acid esters, and hydrocarbon paraffinic mineral oils.

Fatty acid esters that may be used as the release agent include conventional and commonly known fatty acid esters but are not specifically limited thereto.

Examples of fatty acid esters include ester compounds of a fatty acid having a carbon number of 12 to 32, such as lauric acid, palmitic acid, heptadecanoic acid, stearic acid, oleic acid, arachidic acid, or behenic acid, and a monohydric aliphatic alcohol, such as palmityl alcohol, stearyl alcohol, or behenyl alcohol, or a polyhydric aliphatic alcohol, such as glycerin, pentaerythritol, dipentaerythritol, or sorbitan; and composite ester compounds of a fatty acid, a polybasic organic acid, and a monohydric aliphatic alcohol or a polyhydric aliphatic alcohol.

Examples of fatty acid ester lubricants such as described above include cetyl palmitate, butyl stearate, stearyl stearate, stearyl citrate, glycerin monocaprylate, glycerin monocaprate, glycerin monolaurate, glycerin monopalmitate, glycerin dipalmitate, glycerin monostearate, glycerin distearate, glycerin tristearate, glycerin monooleate, glycerin dioleate, glycerin trioleate, glycerin monolinoleate, glycerin monobehenate, glycerin mono-12-hydroxystearate, glycerin di-12-hydroxystearate, glycerin tri-12-hydroxystearate, glycerin diacetomonostearate, glycerin citric acid fatty acid ester, pentaerythritol adipate stearate, montanic acid partially saponified ester, pentaerythritol tetrastearate, dipentaerythritol hexastearate, and sorbitan tristearate.

One of these fatty acid ester lubricants may be used individually, or two or more of these fatty acid ester lubricants may be used in combination.

Examples of commercially available products that may be used include the RIKEMAL series, the POEM series, the RIKESTER series, and the RIKEMASTER series produced by Riken Vitamin Co., Ltd., and the EXCEL series, the RHEODOL series, the EXCEPARL series, and the COCONAD series produced by Kao Corporation. More specific examples include RIKEMAL S-100, RIKEMAL H-100, POEM V-100, RIKEMAL B-100, RIKEMAL HC-100, RIKEMAL S-200, POEM B-200, RIKESTER EW-200, RIKESTER EW-400, EXCEL S-95, and RHEODOL MS-50.

Fatty acid amide lubricants that may be used include conventional and commonly known fatty acid amide lubricants but are not specifically limited thereto.

Examples of fatty acid amide lubricants include saturated fatty acid amides such as lauramide, palmitamide, stearamide, behenamide, and hydroxystearamide; unsaturated fatty acid amides such as oleamide, erucamide, and ricinoleamide; substituted amides such as N-stearyl stearamide, N-oleyl oleamide, N-stearyl oleamide, N-oleyl stearamide, N-stearyl erucamide, and N-oleyl palmitamide; methylol amides such as methylol stearamide and methylol behenamide; saturated fatty acid bisamides such as methylene bisstearamide, ethylene biscapramide, ethylene bislauramide, ethylene bisstearamide (ethylene bis(stearyl amide)), ethylene bisisostearamide, ethylene bishydroxystearamide, ethylene bisbehenamide, hexamethylene bisstearamide, hexamethylene bisbehenamide, hexamethylene bishydroxystearamide, N,N′-distearyl adipamide, and N,N′-distearyl sebacamide; unsaturated fatty acid bisamides such as ethylene bisoleamide, hexamethylene bisoleamide, N,N′-dioleyl adipamide, and N,N′-dioleyl sebacamide; and aromatic bisamides such as m-xylylene bisstearamide and N,N′-distearyl isophthalamide.

One of these fatty acid amide release agents may be used individually, or two or more of these fatty acid amide release agents may be used in combination.

Examples of commercially available products that may be used include the DIAMID series (produced by Nippon Kasei Chemical Co., Ltd.), the AMIDE series (produced by Nippon Kasei Chemical Co., Ltd.), the NIKKA AMIDE series (produced by Nippon Kasei Chemical Co., Ltd.), the METHYLOL AMIDE series (produced by Nippon Kasei Chemical Co., Ltd.), the BISAMIDE series (produced by Nippon Kasei Chemical Co., Ltd.), the SLIPACKS series (produced by Nippon Kasei Chemical Co., Ltd.), the KAO WAX series (produced by Kao Corporation), the FATTY AMIDE series (produced by Kao Corporation), and ethylene bisstearamides (produced by Dainichi Chemical Industry Co., Ltd.).

The term “fatty acid metal salt” refers to a metal salt of a higher fatty acid and examples thereof include lithium stearate, magnesium stearate, calcium stearate, calcium laurate, calcium ricinoleate, strontium stearate, barium stearate, barium laurate, barium ricinoleate, zinc stearate, zinc laurate, zinc ricinoleate, zinc 2-ethylhexanoate, lead stearate, dibasic lead stearate, lead naphthenate, calcium 12-hydroxystearate, and lithium 12-hydroxystearate. Of these fatty acid metal salts, calcium stearate, magnesium stearate, and zinc stearate are particularly preferable because the resultant transparent resin composition has excellent processability and exceptional transparency.

Examples of commercially available products that may be used include the SZ series, the SC series, the SM series, and the SA series produced by Sakai Chemical Industry Co., Ltd.

In a case in which a fatty acid metal salt is used, the content thereof relative to 100 mass % of the methacrylic resin composition is preferably 0.2 mass % or less from a viewpoint of transparency retention.

One release agent such as described above may be used individually, or two or more release agents such as described above may be used together.

The release agent that is used preferably has a decomposition onset temperature of 200° C. or higher. The decomposition onset temperature can be measured through the 1% mass reduction temperature by TGA.

Although the content of the release agent may be any amount that enables an effect as a release agent, excessively high release agent content may lead to problems such as bleed-out during processing and poor extrusion due to screw slipping. Accordingly, the content of the release agent relative to 100 parts by mass of the methacrylic resin is preferably 5 parts by mass or less, more preferably 3 parts by mass or less, even more preferably 1 part by mass or less, further preferably 0.8 parts by mass or less, even further preferably 0.01 parts by mass to 0.8 parts by mass, and particularly preferably 0.01 parts by mass to 0.5 parts by mass. Addition of the release agent in an amount that is within any of the ranges set forth above is preferable because this tends to inhibit poor release in injection molding and adhesion to a metal roller in sheet shaping while also suppressing reduction in transparency caused by addition of the release agent.

—Other Thermoplastic Resins—

The methacrylic resin composition forming the methacrylic resin shaped product according to the present embodiment may contain thermoplastic resins other than the methacrylic resin with the aim of adjusting birefringence or improving flexibility so long as the objectives of this disclosure are not impeded.

Examples of other thermoplastic resins that may be used include polyacrylates such as polybutyl acrylate; styrene polymers such as polystyrene, styrene-methyl methacrylate copolymer, styrene-butyl acrylate copolymer, styrene-acrylonitrile copolymer, and acrylonitrile-butadiene-styrene block copolymer; acrylic rubber particles having a 3 or 4 layer structure described in JP S59-202213 A, JP S63-27516 A, JP S51-129449 A, JP S52-56150 A, and so forth; rubbery polymers disclosed in JP S60-17406 B and JP H8-245854 A; and methacrylic rubber-containing graft copolymer particles obtained by multi-step polymerization described in WO 2014-002491 A1.

Of these other thermoplastic resins, from a viewpoint of obtaining good optical properties and mechanical properties, it is preferable to use a styrene-acrylonitrile copolymer or rubber-containing graft copolymer particles having a grafted portion in a surface layer thereof with a chemical composition that is compatible with the methacrylic resin including a structural unit (B) having a cyclic structure in a main chain.

The average particle diameter of acrylic rubber particles, methacrylic rubber-containing graft copolymer particles, or a rubbery polymer such as described above is preferably 0.03 μm to 1 μm, and more preferably 0.05 μm to 0.5 μm from a viewpoint of improving impact strength, optical properties, and so forth of a film obtained using the composition according to the present embodiment.

The content of other thermoplastic resins relative to 100 parts by mass of the methacrylic resin is preferably 0 parts by mass to 50 parts by mass, and more preferably 0 parts by mass to 25 parts by mass.

(Production Method of Methacrylic Resin Composition)

The method by which the methacrylic resin composition is produced may, for example, be a method of kneading using a kneading machine such as an extruder, a heating roller, a kneader, a roller mixer, or a Banbury mixer. Of these methods, kneading by an extruder is preferable in terms of productivity. The kneading temperature may be set in accordance with the preferred processing temperature of the polymer forming the methacrylic resin or another resin mixed therewith. As a rough guide, the kneading temperature may be within a range of 140° C. to 300° C., and is preferably within a range of 180° C. to 280° C. The extruder is preferably provided with a vent port for reduction of volatile content.

With regards to the methacrylic resin composition, the glass transition temperature (Tg), the amount of methanol-soluble content as a proportion relative to 100 mass %, in total, of methanol-soluble content and methanol-insoluble content, the yellowness index (YI) and transmittance at 680 nm of methanol-insoluble content, the Z average molecular weight (Mz), the weight average molecular weight (Mw), the number average molecular weight (Mn), and the photoelastic coefficient C_{R} may be the same as described in relation to the methacrylic resin.

(Production Method of Methacrylic Resin Shaped Product)

Various shaping methods such as extrusion molding, injection molding, compression molding, calendering, inflation molding, and blow molding may be used as the production method of the methacrylic resin shaped product.

Various shaped products in which the methacrylic resin and resin composition thereof according to the present embodiment are used may be further subjected to surface functionalization treatment such as anti-reflection treatment, transparent conductive treatment, electromagnetic shielding treatment, or gas barrier treatment.

(Properties of Methacrylic Resin Shaped Product)

The following describes properties of the methacrylic resin shaped product according to the present embodiment.

YI of the methacrylic resin shaped product according to the present embodiment at an optical path length of 3 mm is preferably 0 to 2.5, more preferably 0.5 to 2.2, and even more preferably 0.7 to 2.0.

Moreover, the total light transmittance at an optical path length of 3 mm as measured under the same conditions as in measurement of YI is preferably 90% to 94%, more preferably 91% to 93%, and even more preferably 91.5% to 93%.

When YI and total light transmittance at an optical path length of 3 mm are within any of the ranges set forth above, it is possible to obtain adequate color tone and transmittance for practical use in a relatively thin shaped product such as a sheet.

YI and total light transmittance at an optical path length of 3 mm can be measured by a method described in the subsequent EXAMPLES section.

YI of the methacrylic resin shaped product according to the present embodiment at an optical path length of 80 mm is preferably 0 to 35, more preferably 1 to 30, and even more preferably 2 to 30.

Moreover, a Y value at an optical path length of 80 mm as measured under the same conditions as in measurement of YI is preferably 60 to 95, more preferably 65 to 93, and even more preferably 68 to 90. The Y value serves as an indicator of luminous transmittance.

When the YI and Y value at an optical path length of 80 mm are within any of the ranges set forth above, it is possible to obtain color tone and transparency that are suitable even for shaped product applications having a long optical path such as light guide plates.

The YI and Y value at an optical path length of 80 mm can be measured by a method described in the subsequent EXAMPLES section.

(Use of Methacrylic Resin Shaped Product)

Examples of uses for the methacrylic resin shaped product include household goods, OA equipment, AV equipment, battery fittings, lighting equipment, automotive components, housing applications, sanitary applications as a sanitary ware alternative or the like, and optical components.

Examples of automotive components include tail lamps, meter covers, head lamps, light guide rods, lenses, and car navigation system front plates.

Examples of optical components include light guide plates, diffuser plates, polarizing plate protective films, quarter-wave plates, half-wave plates, viewing angle control films, liquid-crystal optical compensation films, other retardation films, display front plates, display base plates, lenses, touch panels, and the like used in displays such as liquid-crystal displays, plasma displays, organic EL displays, field emission displays, and rear projection televisions. Use for transparent substrates and the like of solar cells is also appropriate. Other possible applications include those in the fields of optical communication systems, optical switching systems, and optical measurement systems, or in optical products such as head mounted displays and liquid-crystal projectors for waveguides, lenses, optical fibers, optical fiber coating materials, LED lenses, lens covers, and so forth. Moreover, use as a modifier for another resin is also possible.

### EXAMPLES

Hereinafter, the content of this disclosure is described more specifically through examples and comparative examples. However, this disclosure is not limited to the following examples.

<1. Measurement of Polymerization Conversion Rate>

A portion of the polymerization solution in each production example and comparative production example was sampled, and the polymerization solution sample was dissolved in chloroform to prepare a 5 mass % solution. n-Decane was added to the solution as an internal standard and then the concentration of residual monomer in the sample was measured by a gas chromatograph (GC-2010 produced by Shimadzu Corporation) to determine the total mass (a) of residual monomer in the polymerization solution. The polymerization conversion rate (%) was then calculated from the total mass (a), the total mass (b) in a case in which all monomer added up until the sample was taken was assumed to remain in the polymerization solution, and the total mass (c) of monomer added until the end of the polymerization step using an equation (b−a)/c×100.

<2. Analysis of Structural Units>

Structural units in methacrylic resins produced in the subsequently described production examples were identified and the amounts thereof were calculated by ¹H-NMR measurement and ¹³C-NMR measurement in each of the production examples unless otherwise specified. The measurement conditions in the 1H-NMR measurement and the ¹³C-NMR measurement were as follows.
Measurement apparatus: DPX-400 produced by Bruker Corporation
Measurement solvent: CDCl₃ or DMSO-d₆
Measurement temperature: 40° C.

In a case in which the cyclic structure of the methacrylic resin was a lactone ring structure, the lactone ring structure was confirmed by a method described in JP 2001-151814 A and JP 2007-297620 A.

<3. Measurement of Molecular Weight and Molecular Weight Distribution>

The Z average molecular weight (Mz), weight average molecular weight (Mw), and number average molecular weight (Mn) of methacrylic resins produced in the subsequently described production examples were measured by the following apparatus and conditions.
Measurement apparatus: Gel permeation chromatograph (HLC-8320GPC) produced by Tosoh Corporation
Measurement conditions

Column: TSK guard column Super H-H×1, TSK gel Super HM-M×2, TSK gel Super H2500×1; connected in series in this order

Column temperature: 40° C.

Developing solvent: Tetrahydrofuran; 0.6 mL/min flow rate; 0.1 g/L of 2,6-di-t-butyl-4-methylphenol (BHT) added as internal standard

Detector: Refractive index (RI) detector

Detection sensitivity: 3.0 mV/min

Sample: Solution of 0.02 g of methacrylic resin or methacrylic resin composition in 20 mL of tetrahydrofuran

Injection volume: 10 μL

Standard samples for calibration curve: Following 10 types of polymethyl methacrylate (PMMA Calibration Kit M-M-10 produced by Polymer Laboratories Ltd.) of differing molecular weight, each having a known monodisperse weight peak molecular weight

Weight peak molecular weight (Mp)

Standard sample 1: 1,916,000

Standard sample 2: 625,500

Standard sample 3: 298,900

Standard sample 4: 138,600

Standard sample 5: 60,150

Standard sample 6: 27,600

Standard sample 7: 10,290

Standard sample 8: 5,000

Standard sample 9: 2,810

Standard sample 10: 850

The RI detection intensity was measured with respect to the elution time of the methacrylic resin under the conditions set forth above.

The Z average molecular weight (Mz), weight average molecular weight (Mw) and number average molecular weight (Mn) of the methacrylic resin and the methacrylic resin composition were determined based on a calibration curve obtained through measurement of the calibration curve standard samples.

4. Glass Transition Temperature>

The glass transition temperature (Tg) (° C.) of a methacrylic resin was measured in accordance with JIS K 7121.

First, specimens were obtained by cutting approximately 10 mg from a sample at four points (four locations) after the sample has been conditioned (left for 1 week at 23° C.) in a standard state (23° C., 65% RH).

A DSC curve was then plotted using a differential scanning calorimeter (Diamond DSC produced by PerkinElmer Japan) under a nitrogen gas flow rate of 25 mL/min while heating the specimen from room temperature (23° C.) to 200° C. at 10° C./min (primary heating), holding the specimen at 200° C. for 5 minutes to completely melt the specimen, cooling the specimen from 200° C. to 40° C. at 10° C./min, holding the specimen at 40° C. for 5 minutes, and then reheating the specimen under the same heating conditions (secondary heating). The glass transition temperature (Tg) (° C.) was measured as the intersection point (mid-point glass transition temperature) of a stair-shaped change section of the DSC curve during the secondary heating and a straight line that was equidistant in a vertical axis direction from each extrapolated baseline. Four points were measured per sample and the arithmetic mean (rounded to nearest whole number beyond the decimal point) for the four points was taken to be the measured value.

<5. Measurement of Photoelastic Coefficient C_{R}>

Each methacrylic resin obtained in the production examples and comparative production examples was formed into a pressed film using a vacuum compression molding machine to obtain a measurement sample.

The specific sample preparation conditions were as follows. A vacuum compression molding machine (SFV-30 produced by Shinto Metal Industries Corporation) was pre-heated for 10 minutes at 260° C. under vacuum (approximately 10 kPa) and was then used to compress the resin for 5 minutes at 260° C. and approximately 10 MPa. The vacuum and press pressure were released, and then the resin was transferred to a compression molding machine for cooling in which the resin was cooled and solidified. The resultant pressed film was cured for at least 24 hours in a constant temperature and constant humidity chamber adjusted to a temperature of 23° C. and a humidity of 60%, and then a measurement specimen (thickness: approximately 150 μm, width: 6 mm) was cut out therefrom.

The photoelastic coefficient C_{R} (Pa⁻¹) was measured using a birefringence measurement device that is described in detail in Polymer Engineering and Science 1999, 39, 2349-2357.

The film-shaped specimen was set in a film tensing device (produced by Imoto Machinery Co., Ltd.) set up in the same constant temperature and constant humidity chamber with a chuck separation of 50 mm. Next, a birefringence measurement device (RETS-100 produced by Otsuka Electronics Co., Ltd.) was set up such that a laser light path of the device was positioned in a central portion of the film. The birefringence of the specimen was measured while applying tensile stress with a strain rate of 50%/min (chuck separation: 50 mm, chuck movement speed: 5 mm/min).

The photoelastic coefficient (C_{R}) (Pa⁻¹) was calculated from the relationship between the absolute value (|Δn|) of the measured birefringence and the tensile stress (σ_{R}) by making a least squares approximation and then determining the gradient of the resultant straight line. This calculation was performed using data in a tensile stress range of 2.5 MPa≤σ_{R}≤10 MPa.

C_{R}=|Δn|/σ_{R}

Note that the absolute value (|Δn|) of birefringence is a value shown below.

|Δn|=|nx−ny|

(nx: refractive index of tension direction; ny: refractive index of in-plane direction perpendicular to tension direction)

<6. Measurement of Amount of Methanol-Soluble Content and Amount of Methanol-Insoluble Content>

For each methacrylic resin obtained in the production examples and comparative production examples, 5 g of the methacrylic resin was dissolved in 100 mL of chloroform, and the resultant solution was added into a dropping funnel and was then dripped into 1 L of methanol stirred by a stirrer over approximately 1 hour to cause re-precipitation. After the entire solution had been dripped into the methanol and then been left at rest for 1 hour, suction filtration was performed using a membrane filter (T05A090C produced by Advantec Toyo Kaisha, Ltd.) as a filter.

The filtration residue was vacuum dried for 16 hours at 60° C. and the dried product was taken to be methanol-insoluble content. Additionally, solvent was removed from the filtrate using a rotary evaporator with a bath temperature of 40° C. and a degree of vacuum that was gradually reduced from an initial setting of 390 Torr to a final level of 30 Torr. Soluble content remaining in the rotary evaporator flask was collected and taken to be methanol-soluble content.

The mass of the methanol-insoluble content and the mass of the methanol-soluble content were each weighed and then the amount of the methanol-soluble content was calculated as a proportion (mass %; proportion of methanol-soluble content) relative to the total amount (100 mass %) of the methanol-soluble content and the methanol-insoluble content.

<7. Measurement of Yellowness Index (YI) and Transmittance at 680 Nm>

A measurement sample was obtained by preparing a 20 w/v % chloroform solution of methanol-insoluble content (i.e., a solution prepared with proportions such as 10 g of sample dissolved in chloroform to obtain 50 mL of solution) for each methacrylic resin obtained in the production examples and comparative production examples. A UV-visible spectrophotometer (UV-2500PC produced by Shimadzu Corporation) was used to perform transmittance measurement with a measurement wavelength of 380 nm to 780 nm, a slit width of 2 nm, a 10 cm optical path length cell, and a viewing angle of 10°, and using a supplementary illuminant C and chloroform as a reference.

YI (yellowness index) was calculated in accordance with JIS K 7373 by the following equation

YI=100(1.2769X−1.0592Z)/Y

using the XYZ color system.

The transmittance (%) at a wavelength of 680 nm was recorded under the same conditions as in measurement of YI.

<8. Evaluation of Methacrylic Resin Film Production>

Each methacrylic resin obtained in the subsequently described production examples and comparative production examples was dried for 24 hours at 90° C. using dehumidified air such as to reduce moisture content to 300 mass ppm or less and was then used in film production by the following method.

A film was produced using a twin screw extruder (produced by Technovel Corporation) of 15 mm in diameter having a T-die of 300 mm in width installed in a downstream section thereof. A film of 80 μm in thickness was obtained under film production conditions of an extruder downstream section temperature setting of 260° C., a T-die temperature setting of 255° C., a discharge rate of 1 kg/hr, and a cooling roller temperature setting of 10° C. lower than the glass transition temperature. After continuous operation for 6 hours under these conditions, 1 m in length of film for evaluation was sampled.

A roller that had been sufficiently cleaned prior to film production was used and staining of the roller surface after 6 hours was inspected by eye. An evaluation of “good” was given in a case in which there was almost no change from prior to film production with only slight staining of a small portion of the roller, an evaluation of “mediocre” was given in a case in which there was slight staining of the entire surface of the roller, and an evaluation of “poor” was given in a case in which there was staining of the entire surface of the roller and re-cleaning was necessary.

<9. Measurement of Shaped Piece Color Tone>

### (9-1) Measurement of YI and Total Light Transmittance at Optical Path Length of 3 mm

A spectrophotometer (SD-5000 produced by Nippon Denshoku Industries Co., Ltd.) was used to measure yellowness index (YI) (measured in accordance with JIS K 7373) and total light transmittance (%) (measured in accordance with JIS K 7361-1) of a shaped piece obtained in each of the subsequently described examples and comparative examples with a D65 illuminant, a 10° field of view, and an optical path length of 3 mm by clamping the shaped piece such that the illuminant passed in a thickness direction of the shaped piece. This measurement was performed three times and an average value of these measurements was used.

### (9-2) Measurement of YI and Y Value at Optical Path Length of 80 mm

A shaped piece obtained in each of the subsequently described examples and comparative examples was cut to 80 mm in the longitudinal direction and was then polished at both end surfaces perpendicular to the longitudinal direction using a polishing machine (PLA-BEAUTY produced by Megaro Technica Co., Ltd.) with a cutter rotation speed of 8,500 rpm and a feed rate of 1 m/min.

A color difference meter (COH300A produced by Nippon Denshoku Industries Co., Ltd.) was used to measure the YI and Y value (indicator of luminous transmittance) of the shaped piece that had been subjected to polishing with a C illuminant, a 20 field of view, and an optical path length of 80 mm by setting the shaped piece with the polished end surfaces perpendicular relative to the illuminant.

[Raw Materials]

Raw materials used in the subsequently described production examples and comparative production examples were as shown below.

### [[Monomers]]

Methyl methacrylate: Produced by Asahi Kasei Corporation
N-Phenylmaleimide (phMI): Produced by Nippon Shokubai Co., Ltd.
N-Cyclohexylmaleimide (chMI): Produced by Nippon Shokubai Co., Ltd.
Styrene: Produced by Asahi Kasei Chemicals Corporation
Methyl 2-(hydroxymethyl)acrylate (MHMA): Produced by Combi-Blocks Inc.

### [[Polymerization Initiators]]

1,1-Di(t-butylperoxy)cyclohexane: PERHEXA C produced by NOF Corporation
1,1-Di(t-hexylperoxy)cyclohexane: PERHEXA HC produced by NOF Corporation
t-Butylperoxy isopropyl monocarbonate: PERBUTYL I produced by NOF Corporation
t-Amyl peroxyisononanoate: Luperox 570 produced by Arkema Yoshitomi, Ltd.
t-Butyl peroxy-2-ethylhexanoate: PERBUTYL O produced by NOF Corporation

### [[Chain Transfer Agents]]

n-Octyl mercaptan: Produced by Kao Corporation
n-Dodecyl mercaptan: Produced by Kao Corporation

### Production Example 1: Production of N-Substituted Maleimide Structural Unit-Containing Methacrylic Resin (A)

A mixed monomer solution was obtained by measuring out 146.0 kg of methyl methacrylate (hereinafter, denoted as MMA), 14.6 kg of N-phenylmaleimide (hereinafter, denoted as phMI), 22.0 kg of N-cyclohexylmaleimide (hereinafter, denoted as chMI), 0.174 kg of n-octyl mercaptan as a chain transfer agent, and 147.0 kg of meta-xylene (hereinafter, denoted as mXy), adding these materials into a 1.25 m³ reactor equipped with an impeller and a temperature controller functioning through use of a jacket, and then stirring these materials.

Next, a supplemental mixed monomer solution was obtained by measuring out 271.2 kg of MMA, 27.1 kg of phMI, 40.9 kg of chMI, and 273.0 kg of mXy, adding these materials into a first tank, and stirring these materials.

In addition, 58.0 kg of MMA was measured out into a second tank.

The contents of the reactor were subjected to bubbling with nitrogen for 1 hour at a rate of 30 L/min, and the first and second tanks were each subjected to bubbling with nitrogen for 30 minutes at a rate of 10 L/min to remove dissolved oxygen.

Thereafter, steam was blown into the jacket to raise the solution temperature in the reactor to 124° C., and a polymerization initiator solution of 0.348 kg of 1,1-di(t-butylperoxy)cyclohexane dissolved in 4.652 kg of mXy was added at a rate of 2 kg/hr under stirring at 50 rpm to initiate polymerization.

The solution temperature inside the reactor during polymerization was controlled to 124±+2C through temperature adjustment using the jacket. Once 30 minutes had passed from the start of polymerization, the addition rate of the initiator solution was reduced to 1 kg/hr and the supplemental mixed monomer solution was added from the first tank over 2 hours at 306.1 kg/hr.

Next, once 2 hours and 45 minutes had passed from the start of polymerization, the entire amount of MMA was added from the second tank over 30 minutes at a rate of 116 kg/hr.

Moreover, the addition rate of the initiator solution was reduced to 0.5 kg/hr once 3.5 hours had passed from the start of polymerization, 0.25 kg/hr once 4.5 hours had passed from the start of polymerization, and 0.125 kg/hr once 6 hours had passed from the start of polymerization, and addition of the initiator solution was stopped once 7 hours had passed from the start of polymerization.

A polymerization solution containing a methacrylic resin having a cyclic structure-containing main chain was obtained once 10 hours had passed from the start of polymerization.

The 1,1-di(t-butylperoxy)cyclohexane used as an initiator had a one-hour half-life temperature of 111° C., a one-minute half-life temperature of 154° C., and a half-life of 16 minutes at a polymerization temperature of 124° C.

The polymer solution was sampled 4 hours after the start of polymerization, 6 hours after the start of polymerization, 8 hours after the start of polymerization, and 10 hours after the start of polymerization (i.e., at the end of polymerization), and the polymerization conversion rate was analyzed from the concentration of residual monomer. The polymerization conversion rate was 84.8% after 4 hours, 93.3% after 6 hours, 95.7% after 8 hours, and 96.0% after 10 hours.

The polymerization solution was fed into a concentrating device comprising a tubular heat exchanger and a vaporization tank that had been pre-heated to 170° C., and the concentration of polymer contained in the solution was increased to 70 mass %.

The resultant polymerization solution was fed into a thin film evaporator having a heat transfer area of 0.2 m² to perform devolatilization.

This devolatilization was performed with an evaporator internal temperature of 280° C., a feed rate of 30 L/hr, a rotation speed of 400 rpm, and a degree of vacuum of 30 Torr. The polymerized product obtained after devolatilization was pressurized by a gear pump and was extruded from a strand die. The extruded polymerized product was cooled by water and subsequently pelletized to obtain an N-substituted maleimide structural unit-containing methacrylic resin (A).

The chemical composition of the resultant pellet-form polymerized product was confirmed to include structural units derived from the monomers MMA, phMI, and chMI in proportions of 81.3 mass %, 7.9 mass %, and 10.8 mass %, respectively. The weight average molecular weight was 141,000, Mz/Mw was 1.54, and Mw/Mn was 1.94. Other physical properties are shown in Table 2.

### Production Example 2: Production of N-Substituted Maleimide Structural Unit-Containing Methacrylic Resin (B)

A mixed monomer solution was obtained by measuring out 176.2 kg of MMA, 6.0 kg of phMI, 10.3 kg of chMI, 0.168 kg of n-octyl mercaptan as a chain transfer agent, and 153.7 kg of mXy, adding these materials into a 1.25 m³ reactor equipped with an impeller and a temperature controller functioning through use of a jacket, and then stirring these materials.

Next, a supplemental mixed monomer solution was obtained by measuring out 327.1 kg of MMA, 11.2 kg of phMI, 19.2 kg of chMI, and 285.3 kg of mXy, adding these materials into a first tank, and stirring these materials.

In addition, 11.0 kg of styrene was measured out into a second tank. The contents of the reactor were subjected to bubbling with nitrogen for 1 hour at a rate of 30 L/min, and the first and second tanks were each subjected to bubbling with nitrogen for 30 minutes at a rate of 10 L/min to remove dissolved oxygen.

Thereafter, steam was blown into the jacket to raise the solution temperature in the reactor to 124° C., and a polymerization initiator solution of 0.337 kg of 1,1-di(t-hexylperoxy)cyclohexane dissolved in 4.663 kg of mXy was added at a rate of 2 kg/hr under stirring at 50 rpm to initiate polymerization.

The solution temperature inside the reactor during polymerization was controlled to 124±+2C through temperature adjustment using the jacket. Once 30 minutes had passed from the start of polymerization, the addition rate of the initiator solution was reduced to 1 kg/hr and the supplemental mixed monomer solution was added from the first tank over 2.5 hours at 257.1 kg/hr.

Next, once 3 hours and 30 minutes had passed from the start of polymerization, the entire amount of styrene was added from the second tank over 15 minutes at a rate of 44 kg/hr.

Moreover, the addition rate of the initiator solution was reduced to 0.5 kg/hr once 3.5 hours had passed from the start of polymerization, 0.25 kg/hr once 4.5 hours had passed from the start of polymerization, and 0.125 kg/hr once 6 hours had passed from the start of polymerization, and addition of the initiator solution was stopped once 7 hours had passed from the start of polymerization.

A polymerization solution containing a methacrylic resin having a cyclic structure-containing main chain was obtained once 10 hours had passed from the start of polymerization.

The 1,1-di(t-hexylperoxy)cyclohexane used as an initiator had a one-hour half-life temperature of 107° C., a one-minute half-life temperature of 149° C., and a half-life of 11 minutes at a polymerization temperature of 124° C.

The polymer solution was sampled 4 hours after the start of polymerization, 6 hours after the start of polymerization, 8 hours after the start of polymerization, and 10 hours after the start of polymerization (i.e., at the end of polymerization), and the polymerization conversion rate was analyzed from the concentration of residual monomer. The polymerization conversion rate was 84.5% after 4 hours, 92.2% after 6 hours, 95.2% after 8 hours, and 95.5% after 10 hours.

The polymerization solution was fed into a concentrating device comprising a tubular heat exchanger and a vaporization tank that had been pre-heated to 170° C., and the concentration of polymer contained in the solution was increased to 70 mass %. The resultant polymerization solution was fed into a thin film evaporator having a heat transfer area of 0.2 m² to perform devolatilization.

This devolatilization was performed with an evaporator internal temperature of 280° C., a feed rate of 30 L/hr, a rotation speed of 400 rpm, and a degree of vacuum of 30 Torr. The polymerized product obtained after devolatilization was pressurized by a gear pump and was extruded from a strand die. The extruded polymerized product was cooled by water and subsequently pelletized to obtain an N-substituted maleimide structural unit-containing methacrylic resin (B).

The chemical composition of the resultant pellet-form polymerized product was confirmed to include structural units derived from the monomers MMA, phMI, chMI, and styrene in proportions of 89.8 mass %, 3.5 mass %, 5.1 mass %, and 1.6 mass %, respectively. The weight average molecular weight was 133,000, Mz/Mw was 1.58, and Mw/Mn was 2.07. Other physical properties are shown in Table 2.

### Production Example 3: Production of N-Substituted Maleimide Structural Unit-Containing Methacrylic Resin (C)

A mixed monomer solution was obtained by measuring out 500 kg of MMA, 39.6 kg of phMI, 10.4 kg of chMI, 0.275 kg of n-octyl mercaptan as a chain transfer agent, and 450 kg of mXy, adding these materials into a 1.25 m³ reactor equipped with an impeller and a temperature controller functioning through use of a jacket, and then stirring these materials.

The contents of the reactor were subjected to bubbling with nitrogen for 1 hour at a rate of 30 L/min to remove dissolved oxygen. Thereafter, steam was blown into the jacket to raise the solution temperature in the reactor to 120° C., and a polymerization initiator solution of 0.175 kg of 1,1-di(t-butylperoxy)cyclohexane dissolved in 3.000 kg of mXy was added at a rate of 1.5 kg/hr under stirring at 50 rpm to initiate polymerization.

The solution temperature inside the reactor during polymerization was controlled to 120±2° C. through temperature adjustment using the jacket. The addition rate of the initiator solution was reduced to 0.75 kg/hr once 30 minutes had passed from the start of polymerization, 0.5 kg/hr once 2 hours had passed from the start of polymerization, and 0.2 kg/hr once 3 hours had passed from the start of polymerization, and addition of the initiator solution was stopped once 7 hours had passed from the start of polymerization.

A polymerization solution containing a methacrylic resin having a cyclic structure-containing main chain was obtained once 10 hours had passed from the start of polymerization.

The 1,1-di(t-butylperoxy)cyclohexane used as an initiator had a one-hour half-life temperature of 111° C., a one-minute half-life temperature of 154° C., and a half-life of 24 minutes at a polymerization temperature of 120° C.

The polymer solution was sampled 5 hours after the start of polymerization, 8 hours after the start of polymerization, and 10 hours after the start of polymerization (i.e., at the end of polymerization), and the polymerization conversion rate was analyzed from the concentration of residual monomer. The polymerization conversion rate was 85.0% after 5 hours, 93.3% after 8 hours, and 94.0% after 10 hours.

The polymerization solution was fed into a concentrating device comprising a tubular heat exchanger and a vaporization tank that had been pre-heated to 170° C., and the concentration of polymer contained in the solution was increased to 70 mass %.

The resultant polymerization solution was fed into a thin film evaporator having a heat transfer area of 0.2 m² to perform devolatilization.

This devolatilization was performed with an evaporator internal temperature of 280° C., a feed rate of 30 L/hr, a rotation speed of 400 rpm, and a degree of vacuum of 30 Torr. The polymerized product obtained after devolatilization was pressurized by a gear pump and was extruded from a strand die. The extruded polymerized product was cooled by water and subsequently pelletized to obtain an N-substituted maleimide structural unit-containing methacrylic resin (C).

The chemical composition of the resultant pellet-form polymerized product was confirmed to include structural units derived from the monomers MMA, phMI, and chMI in proportions of 91.1 mass %, 7.3 mass %, and 1.6 mass %, respectively. The weight average molecular weight was 151,000, Mz/Mw was 1.75, and Mw/Mn was 2.29. Other physical properties are shown in Table 2.

### Production Example 4: Production of N-Substituted Maleimide Structural Unit-Containing Methacrylic Resin (D)

A mixed monomer solution was obtained by measuring out 112.5 kg of MMA, 12.5 kg of phMI, 0.50 kg of n-octyl mercaptan as a chain transfer agent, and 125 kg of toluene, adding these materials into a 1.25 m³ reactor equipped with an impeller and a temperature controller functioning through use of a jacket, and then stirring these materials. Next, a supplemental mixed monomer solution was obtained by measuring out 337.5 kg of MMA, 37.5 kg of phMI, and 375 kg of toluene, adding these materials into a first tank, and stirring these materials.

The contents of the reactor were subjected to bubbling with nitrogen for 1 hour at a rate of 30 L/min, and the contents of the first tank were subjected to bubbling with nitrogen for 30 minutes at a rate of 10 L/min to remove dissolved oxygen.

Thereafter, steam was blown into the jacket to raise the solution temperature in the reactor to 110° C., and a polymerization initiator solution of 0.5 kg of t-butylperoxy isopropyl monocarbonate dissolved in 1 kg of toluene was added under stirring at 50 rpm to initiate polymerization. Moreover, a polymerization initiator solution of 0.75 kg of t-butylperoxy isopropyl monocarbonate dissolved in 1.5 kg of toluene was added over 1 hour at a constant rate.

Once 30 minutes had passed from the start of polymerization, the contents of the first tank were added over 2 hours at a constant rate.

The solution temperature inside the reactor during polymerization was controlled to 110±2° C. through temperature adjustment using the jacket. A polymerization solution containing a methacrylic resin having a cyclic structure-containing main chain was obtained once 12 hours had passed from the start of polymerization.

The t-butylperoxy isopropyl monocarbonate that was used as an initiator had a one-hour half-life temperature of 118° C. and a half-life of 153 minutes at a polymerization temperature of 110° C. The polymer solution was sampled 5.5 hours after the start of polymerization, 7 hours after the start of polymerization, 10 hours after the start of polymerization, and 12 hours after the start of polymerization (i.e., at the end of polymerization), and the polymerization conversion rate was analyzed from the concentration of residual monomer. The polymerization conversion rate was 84.2% after 5.5 hours, 90.0% after 7 hours, 95% after 10 hours, and 97.3% after 12 hours.

The polymerization solution was fed into a concentrating device comprising a tubular heat exchanger and a vaporization tank that had been pre-heated to 170° C., and the concentration of polymer contained in the solution was increased to 70 mass %.

The resultant polymerization solution was fed into a thin film evaporator having a heat transfer area of 0.2 m² to perform devolatilization. This devolatilization was performed with an evaporator internal temperature of 280° C., a feed rate of 30 L/hr, a rotation speed of 400 rpm, and a degree of vacuum of 30 Torr. The polymerized product obtained after devolatilization was pressurized by a gear pump and was extruded from a strand die. The extruded polymerized product was cooled by water and subsequently pelletized to obtain an N-substituted maleimide structural unit-containing methacrylic resin (D).

The chemical composition of the resultant pellet-form polymerized product was confirmed to include structural units derived from the monomers MMA and phMI in proportions of 90.1 mass % and 9.9 mass %, respectively.

The weight average molecular weight was 145,000, Mz/Mw was 1.65, and Mw/Mn was 2.16. Other physical properties are shown in Table 2.

### Production Example 5: Production of Lactone Ring Structural Unit-Containing Methacrylic Resin (E)

An autoclave that had been internally purged with nitrogen in advance and that included a stirring device, a temperature sensor, a condenser, and a nitrogen gas supply tube was charged with 20 parts by mass of methyl methacrylate, 5 parts by mass of methyl 2-(hydroxymethyl)acrylate, 25 parts by mass of toluene, and 0.025 parts by mass of tris(2,4-di-t-butylphenyl) phosphite as an organophosphorus compound.

Thereafter, heating was performed to 100° C. while introducing nitrogen gas, and then 0.05 parts by mass of t-amyl peroxyisononanoate was added as a polymerization initiator while simultaneously starting dripping of a toluene solution containing 0.075 parts by mass of t-amyl peroxyisononanoate. The toluene solution was dripped in over 1.5 hours while carrying out solution polymerization at approximately 105° C. to 110° C. under reflux, and then polymerization was continued for a further 5.5 hours. Moreover, once 30 minutes had passed from the start of polymerization, 20 parts by mass of methyl methacrylate, 5 parts by mass of methyl 2-(hydroxymethyl)acrylate, and 25 parts by mass of toluene were added over 2 hours at a constant rate.

Next, 0.05 parts by mass of a stearyl phosphate/distearyl phosphate mixture (organophosphorus compound) was added to the resultant polymerization solution as a cyclization catalyst and a cyclocondensation reaction was carried out for 2 hours at approximately 90° C. to 102° C. under reflux.

The t-amyl peroxyisononanoate used as an initiator had a one-hour half-life temperature of 114° C., a half-life of 101 minutes at a polymerization temperature of 110° C., and a half-life of 180 minutes at a polymerization temperature of 105° C. The polymer solution was sampled 4 hours after the start of polymerization and 7.5 hours after the start of polymerization, and the polymerization conversion rate was analyzed from the concentration of residual monomer. The polymerization conversion rate was 84.6% after 4 hours and 94.8% after 7.5 hours. The temporal average of the polymerization temperature from 0 hours to 7.5 hours after the start of polymerization was 105° C.

The resultant polymer solution was subsequently heated to 240° C. in a heater comprising a multi-tube heat exchanger and was then introduced into a twin screw extruder equipped with a plurality of vent ports for devolatilization and a plurality of downstream side-feeding ports so as to continue the cyclization reaction while performing devolatilization.

In the twin screw extruder, the obtained copolymer solution was fed at 15 kg/hr in terms of resin, and conditions of a barrel temperature of 250° C., a rotation speed of 100 rpm, and a degree of vacuum of 10 Torr to 300 Torr were adopted.

Resin composition subjected to melt-kneading by the twin screw extruder was extruded from a strand die, cooled by water, and subsequently pelletized to obtain a resin composition.

The chemical composition of the resultant resin composition was confirmed to contain lactone ring structural units with a content of 32.8 mass %. The lactone ring structural unit content was determined in accordance with a method described in JP 2007-297620 A. The resultant resin composition had a weight average molecular weight of 124,000, Mz/Mw of 1.62, and Mw/Mn of 2.13. Other physical properties are shown in Table 2.

### Comparative Production Example 1: Production of N-Substituted Maleimide Structural Unit-Containing Methacrylic Resin (F)

A mixed monomer solution was obtained by measuring out 445.5 kg of MMA, 44.0 kg of phMI, 60.5 kg of chMI, 0.55 kg of n-octyl mercaptan as a chain transfer agent, and 450 kg of mXy, adding these materials into a 1.25 m³ reactor equipped with an impeller and a temperature controller functioning through use of a jacket, and then stirring these materials.

The contents of the reactor were subjected to bubbling with nitrogen for 1 hour at a rate of 30 L/min to remove dissolved oxygen. Thereafter, steam was blown into the jacket to raise the solution temperature in the reactor to 130° C., and a polymerization initiator solution of 1.10 kg of t-butyl peroxy-2-ethylhexanoate dissolved in 4.9 kg of mXy was added for 6 hours at a rate of 1 kg/hr under stirring at 50 rpm to initiate polymerization.

The solution temperature inside the reactor during polymerization was controlled to 130±2° C. through temperature adjustment using the jacket. A polymerization solution containing a methacrylic resin having a cyclic structure-containing main chain was obtained once 8 hours had passed from the start of polymerization. The t-butyl peroxy-2-ethylhexanoate used as an initiator had a one-hour half-life temperature of 92° C., a one-minute half-life temperature of 134° C., and a half-life of 1.4 minutes at a polymerization temperature of 130° C. The polymer solution was sampled 3.3 hours after the start of polymerization, 6 hours after the start of polymerization, and 8 hours after the start of polymerization (i.e., at the end of polymerization), and the polymerization conversion rate was analyzed from the concentration of residual monomer. The polymerization conversion rate was 84.9% after 3.3 hours, 96.7% after 6 hours, and 96.8% after 8 hours.

The polymerization solution was fed into a concentrating device comprising a tubular heat exchanger and a vaporization tank that had been pre-heated to 170° C., and the concentration of polymer contained in the solution was increased to 70 mass %. The resultant polymerization solution was fed into a thin film evaporator having a heat transfer area of 0.2 m² to perform devolatilization. This devolatilization was performed with an evaporator internal temperature of 280° C., a feed rate of 30 L/hr, a rotation speed of 400 rpm, and a degree of vacuum of 30 Torr. The polymerized product obtained after devolatilization was pressurized by a gear pump and was extruded from a strand die. The extruded polymerized product was cooled by water and subsequently pelletized to obtain an N-substituted maleimide structural unit-containing methacrylic resin (F).

The chemical composition of the resultant pellet-form polymerized product was confirmed to include structural units derived from the monomers MMA, phMI, and chMI in proportions of 81.3 mass %, 7.7 mass %, and 11 mass %, respectively. The weight average molecular weight was 143,000, Mz/Mw was 1.85, and Mw/Mn was 2.75. Other physical properties are shown in Table 2.

### Comparative Production Example 2: Production of N-Substituted Maleimide Structural Unit-Containing Methacrylic Resin (G)

A mixed monomer solution was obtained by measuring out 450.0 kg of MMA, 50.0 kg of phMI, 0.50 kg of n-dodecyl mercaptan as a chain transfer agent, and 500 kg of toluene, adding these materials into a 1.25 m³ reactor equipped with an impeller and a temperature controller functioning through use of a jacket, and then stirring these materials.

The contents of the reactor were subjected to bubbling with nitrogen for 1 hour at a rate of 30 L/min to remove dissolved oxygen. Thereafter, steam was blown into the jacket to raise the solution temperature in the reactor to 110° C., and a polymerization initiator solution of 1.50 kg of t-butylperoxy isopropyl monocarbonate dissolved in 4.5 kg of toluene was added under stirring at 50 rpm to initiate polymerization.

The solution temperature inside the reactor during polymerization was controlled to 110±2° C. through temperature adjustment using the jacket. A polymerization solution containing a methacrylic resin having a cyclic structure-containing main chain was obtained once 12 hours had passed from the start of polymerization.

The t-butylperoxy isopropyl monocarbonate that was used as an initiator had a one-hour half-life temperature of 118° C. and a half-life of 153 minutes at a polymerization temperature of 110° C.

The polymer solution was sampled 4 hours after the start of polymerization, 8 hours after the start of polymerization, and 12 hours after the start of polymerization (i.e., at the end of polymerization), and the polymerization conversion rate was analyzed from the concentration of residual monomer. The polymerization conversion rate was 90.4% after 4 hours, 96.5% after 8 hours, and 98.0% after 12 hours.

The polymerization solution was fed into a concentrating device comprising a tubular heat exchanger and a vaporization tank that had been pre-heated to 170° C., and the concentration of polymer contained in the solution was increased to 70 mass %.

The resultant polymerization solution was fed into a thin film evaporator having a heat transfer area of 0.2 m² to perform devolatilization. This devolatilization was performed with an evaporator internal temperature of 280° C., a feed rate of 30 L/hr, a rotation speed of 400 rpm, and a degree of vacuum of 30 Torr. The polymerized product obtained after devolatilization was pressurized by a gear pump and was extruded from a strand die. The extruded polymerized product was cooled by water and subsequently pelletized to obtain an N-substituted maleimide structural unit-containing methacrylic resin (G).

The chemical composition of the resultant pellet-form polymerized product was confirmed to include structural units derived from the monomers MMA and phMI in proportions of 90.3 mass % and 9.7 mass %, respectively.

The weight average molecular weight was 155,000, Mz/Mw was 1.82, and Mw/Mn was 2.63. Other physical properties are shown in Table 2.

### Comparative Production Example 3: Production of N-Substituted Maleimide Structural Unit-Containing Methacrylic Resin (H)

A mixed monomer solution was obtained by measuring out 140.0 kg of MMA, 100.0 kg of chMI, and 250 kg of toluene, adding these materials into a 1.25 m³ reactor equipped with an impeller and a temperature controller functioning through use of a jacket, and stirring these materials.

Next, a supplemental mixed monomer solution was obtained by measuring out 82.5 kg of MMA, 25.0 kg of chMI, 35.0 kg of styrene, and 200.0 kg of toluene, adding these materials into a first tank, and stirring these materials.

In addition, a supplemental mixed monomer solution was obtained by measuring out 82.5 kg of MMA, 35.0 kg of styrene, and 50.0 kg of toluene, adding these materials into a second tank, and stirring these materials.

The contents of the reactor were subjected to bubbling with nitrogen for 1 hour at a rate of 30 L/min, and the contents of the first and second tanks were each subjected to bubbling with nitrogen for 30 minutes at a rate of 10 L/min to remove dissolved oxygen.

Thereafter, steam was blown into the jacket to raise the solution temperature in the reactor to 110° C., a polymerization initiator solution of 0.20 kg of t-butylperoxy isopropyl monocarbonate dissolved in 0.8 kg of toluene was added under stirring at 50 rpm to initiate polymerization, and a polymerization initiator solution of 2.30 kg of t-butylperoxy isopropyl monocarbonate dissolved in 4.70 kg of toluene was added over 3.5 hours at a rate of 2 kg/hr.

The contents of first tank were added at a constant rate over 3.5 hours from the start of polymerization, and subsequently the contents of the second tank were added at a constant rate over 3.5 hours.

The solution temperature inside the reactor during polymerization was controlled to 110±2° C. through temperature adjustment using the jacket. A polymerization solution containing a methacrylic resin having a cyclic structure-containing main chain was obtained once 12 hours had passed from the start of polymerization.

The t-butylperoxy isopropyl monocarbonate that was used as an initiator had a one-hour half-life temperature of 118° C. and a half-life of 153 minutes at a polymerization temperature of 110° C.

The polymer solution was sampled 7 hours after the start of polymerization, 10 hours after the start of polymerization, and 12 hours after the start of polymerization (i.e., at the end of polymerization), and the polymerization conversion rate was analyzed from the concentration of residual monomer. The polymerization conversion rate was 90.1% after 7 hours, 97.3% after 10 hours, and 98.4% after 12 hours.

The polymerization solution was fed into a concentrating device comprising a tubular heat exchanger and a vaporization tank that had been pre-heated to 170° C., and the concentration of polymer contained in the solution was increased to 70 mass %.

The resultant polymerization solution was fed into a thin film evaporator having a heat transfer area of 0.2 m² to perform devolatilization. This devolatilization was performed with an evaporator internal temperature of 280° C., a feed rate of 30 L/hr, a rotation speed of 400 rpm, and a degree of vacuum of 30 Torr. The polymerized product obtained after devolatilization was pressurized by a gear pump and was extruded from a strand die. The extruded polymerized product was cooled by water and subsequently pelletized to obtain an N-substituted maleimide structural unit-containing methacrylic resin (H).

The chemical composition of the resultant pellet-form polymerized product was confirmed to include structural units derived from the monomers MMA, chMI, and styrene in proportions of 60.3 mass %, 25.5 mass %, and 14.2 mass %, respectively. The weight average molecular weight was 102,000, Mz/Mw was 1.90, and Mw/Mn was 2.84. Other physical properties are shown in Table 2.

### Comparative Production Example 4: Production of Lactone Ring Structural Unit-Containing Methacrylic Resin (I)

An autoclave that had been internally purged with nitrogen in advance and that included a stirring device, a temperature sensor, a condenser, and a nitrogen gas supply tube was charged with 40 parts by mass of methyl methacrylate, 10 parts by mass of methyl 2-(hydroxymethyl)acrylate, 50 parts by mass of toluene, and 0.025 parts by mass of tris(2,4-di-t-butylphenyl) phosphite as an organophosphorus compound.

Thereafter, heating was performed to 100° C. while introducing nitrogen gas, and then 0.05 parts by mass of t-amyl peroxyisononanoate was added as a polymerization initiator while simultaneously starting dripping of a toluene solution containing 0.1 parts by mass of t-amyl peroxyisononanoate.

The toluene solution was dripped in over 2 hours while carrying out solution polymerization at approximately 105° C. to 110° C. under reflux, and then polymerization was continued for a further 4 hours.

Next, 0.05 parts by mass of a stearyl phosphate/distearyl phosphate mixture (organophosphorus compound) was added to the resultant polymerization solution as a cyclization catalyst and a cyclocondensation reaction was carried out for 2 hours at approximately 90° C. to 102° C. under reflux.

The t-amyl peroxyisononanoate used as an initiator had a one-hour half-life temperature of 114° C., a half-life of 101 minutes at a polymerization temperature of 110° C., and a half-life of 180 minutes at a polymerization temperature of 105° C.

The polymer solution was sampled 4 hours after the start of polymerization and 6 hours after the start of polymerization, and the polymerization conversion rate was analyzed from the concentration of residual monomer. The polymerization conversion rate was 89.8% after 4 hours and 95.2% after 6 hours.

The resultant polymer solution was subsequently heated to 240° C. in a heater comprising a multi-tube heat exchanger and was then introduced into a twin screw extruder equipped with a plurality of vent ports for devolatilization and a plurality of downstream side-feeding ports so as to continue the cyclization reaction while performing devolatilization.

In the twin screw extruder, the obtained copolymer solution was fed at 15 kg/hr in terms of resin, and conditions of a barrel temperature of 250° C., a rotation speed of 100 rpm, and a degree of vacuum of 10 Torr to 300 Torr were adopted.

Resin composition subjected to melt-kneading by the twin screw extruder was extruded from a strand die, cooled by water, and subsequently pelletized to obtain a resin composition.

The chemical composition of the resultant resin composition was confirmed to contain lactone ring structural units with a content of 31.5 mass %. The lactone ring structural unit content was determined in accordance with a method described in JP 2007-297620 A. The resultant resin composition had a weight average molecular weight of 121,000, Mz/Mw of 1.78, and Mw/Mn of 2.52. Other physical properties are shown in Table 2.

TABLE 2

| | | | | | Production | | Production | | Production | | Production | | Production | |
|---|---|---|---|---|---|---|---|---|---|---|---|---|---|---|
| | | | | | Example 1 | | Example 2 | | Example 3 | | Example 4 | | Example 5 | |
| Methacrylic | Polymerization method | | | | First | | First | | First | | Second | | Second | |
| resin | | | | | poly- | | poly- | | poly- | | poly- | | poly- | |
| production | | | | | merization | | merization | | merization | | merization | | merization | |
| nethod | | | | | method | | method | | method | | nethod | | method | |
| | Polymerization temperature | | | [° C.] | 124 | | 124 | | 120 | | 110 | | 105 | |
| | Initiator | | Type | [—] | PHC | | PHHC | | PHC | | PBI | | L570 | |
| | | | Half-life | [Min] | 16 | | 11 | | 24 | | 153 | | 180 | |
| Methacrylic | 1 | Polymerization | | [%] | 4 hr | 84.8 | 4 hr | 84.5 | 5 hr | 85 | 5.5 hr | 84.2 | 4 hr | 84.6 |
| resin | | conversion rate | | | 6 hr | 93.3 | 6 hr | 92.2 | 8 hr | 93.3 | 7 hr | 90 | 6 hr | 93.1 |
| | | | | | 8 hr | 95.7 | 8 hr | 95.2 | 10 hr | 94 | 10 hr | 95 | 8 hr | 95.5 |
| | | | | | 10 hr | 96 | 10 hr | 95.5 | | | 12 hr | 97.3 | 9 hr | 97 |

| | 3 | Molecular | Mz | [—] | 217,000 | 210,000 | 264,000 | 239,000 | 201,000 | | | |
|---|---|---|---|---|---|---|---|---|---|---|---|---|
| | | weight | Mw | [—] | 141,000 | 133,000 | 151,000 | 145,000 | 124,000 | | | |
| | | | Mn | [—] | 73,000 | 64,000 | 66,000 | 67,000 | 58,000 | | | |
| | | | Mz/Mw | [—] | 1.54 | 1.58 | 1.75 | 1.65 | 1.62 | | | |
| | | | Mw/Mn | [—] | 1.94 | 2.07 | 2.29 | 2.16 | 2.13 | | | |
| | 4 | Tg | | [° C.] | 135 | 123 | 128 | 129 | 129 | | | |
| | 5 | CR | | [Pa⁻¹] | 0.2 × 10⁻¹² | 1.4 × 10⁻¹² | 0.9 × 10⁻¹² | 0.5 × 10⁻¹² | 2.0 × 10⁻¹² | | | |
| | 6 | Proportion of soluble | | [Mass | 1.8 | 2.1 | 2.5 | 3.8 | 4.2 | | | |
| | | content | | %] | | | | | | | | |
| | 7 | Insoluble | YI | [—] | 3.8 | 3.5 | 5.2 | 4.5 | 4.2 | | | |
| | | content | Transmittance | [%] | 92.1 | 91.5 | 91.8 | 92.2 | 91.2 | | | |
| | | | at 680 nm | | | | | | | | | |
| | 8 | Film production staining | | [—] | Good | Good | Good | Good | Good | | | |
| | | | | | Comparative | | Comparative | | Comparative | | Comparative | |
| | | | | | Production | | Production | | Production | | Production | |
| | | | | | Example 1 | | Example 2 | | Example 3 | | Example 4 | |
| Methacrylic | Polymerization method | | | | First | | Second | | Second | | Second | |
| resin | | | | | poly- | | poly- | | poly- | | poly- | |
| production | | | | | merization | | merization | | merization | | merization | |
| nethod | | | | | method | | nethod | | method | | method | |
| | Polymerization temperature | | | [° C.] | 130 | | 110 | | 110 | | 105 | |
| | | Initiator | Type | [—] | PBO | | PBI | | PBI | | L570 | |
| | | | Half-life | [Min] | 1.4 | | 153 | | 153 | | 180 | |
| Methacrylic | 1 | Polymerization | | [%] | 3.3 hr | 84.9 | | | | | 4 hr | 89.8 |
| resin | | conversion rate | | | 4 hr | 90.1 | 4 hr | 90.4 | 7 hr | 90.1 | 6 hr | 95.2 |
| | | | | | 6 hr | 96.7 | 8 hr | 96.5 | 10 hr | 97.3 | 8 hr | 97 |
| | | | | | 8 hr | 96.8 | 12 hr | 98 | 12 hr | 98.4 | | |

| 3 | Molecular | Mz | [—] | 265,000 | 282,000 | 194,000 | 215,000 |
|---|---|---|---|---|---|---|---|
| | weight | Mw | [—] | 143,000 | 155,000 | 102,000 | 121,000 |
| | | Mn | [—] | 52,000 | 59,000 | 35,800 | 48,000 |
| | | Mz/Mw | [—] | 1.85 | 1.82 | 1.9 | 1.78 |
| | | Mw/Mn | [—] | 2.75 | 2.63 | 2.84 | 2.52 |
| 4 | Tg | | [° C.] | 135 | 128 | 133 | 129 |
| 5 | CR | | [Pa⁻¹] | 0.2 × 10⁻¹² | 0.5 × 10⁻¹² | 2.5 × 10⁻¹² | 2.2 × 10⁻¹² |
| 6 | Proportion of soluble | | [Mass | 8.3 | 7.2 | 6.8 | 9.8 |
| | content | | %] | | | | |
| 7 | Insoluble | YI | [—] | 8.3 | 8.8 | 4.7 | 7.9 |
| | content | Transmittance | [%] | 91.5 | 91.4 | 88.5 | 90.7 |
| | | at 680 nm | | | | | |

| | | | | | | |
|---|---|---|---|---|---|---|
| 8 | Film production staining | [—] | Poor | Poor | Mediocre | Mediocre |

(Note)
* Resin composition
PHC: 1,1-Di(t-butylperoxy)cyclohexane
PHHC: 1,1-Di(t-hexylperoxy)cyclohexane
PBI: t-Butylperoxy isopropyl monocarbonate
L570: t-Amyl peroxyisononanoate
PBO: t-Butyl peroxy-2-ethylhexanoate

### Examples 1 to 5 and Comparative Examples 1 to 4

The methacrylic resins (A) to (I) obtained in Production Examples 1 to 5 and Comparative Production Examples 1 to 4 were used to prepare strip-like shaped pieces of 3 mm in thickness by 12 mm in width by 124 mm in length in an injection molding machine (AUTO SHOT C Series MODEL 15A produced by Fanuc Corporation) under conditions of a molding temperature of 250° C. and a mold temperature of 90° C.

<9. Measurement of Shaped Piece Color Tone>

### (9-1) Measurement of YI and Total Light Transmittance at Optical Path Length of 3 mm

A spectrophotometer (SD-5000 produced by Nippon Denshoku Industries Co., Ltd.) was used to measure yellowness index (YI) (measured in accordance with JIS K 7373) and total light transmittance (%) (measured in accordance with JIS K 7361-1) of an obtained shaped piece with a D65 illuminant, a 100 field of view, and an optical path length of 3 mm by clamping the shaped piece such that the illuminant passed in a thickness direction of the shaped piece. This measurement was performed three times and an average value of these measurements was used.

### (9-2) Measurement of YI and Y Value at Optical Path Length of 80 mm

An obtained shaped piece was cut to 80 mm in the longitudinal direction and was then polished at both end surfaces perpendicular to the longitudinal direction using a polishing machine (PLA-BEAUTY produced by Megaro Technica Co., Ltd.) with a cutter rotation speed of 8,500 rpm and a feed rate of 1 m/min.

A color difference meter (COH300A produced by Nippon Denshoku Industries Co., Ltd.) was used to measure the YI and Y value (indicator of luminous transmittance) of the shaped piece that had been subjected to polishing with a C illuminant, a 20 field of view, and an optical path length of 80 mm by setting the shaped piece with the polished end surfaces perpendicular relative to the illuminant.

Color tone measurement was performed for each shaped piece. The measurement values that were obtained are shown in Table 3.

TABLE 3

| | | | | | Exam- | Exam- | Exam- | Exam- | Exam- | Com- | Com- | Com- | Com- |
|---|---|---|---|---|---|---|---|---|---|---|---|---|---|
| | | | | | ple | ple | ple | ple | ple | parative | parative | parative | parative |
| | | | | | 1 | 2 | 3 | 4 | 5 | Example 1 | Example 2 | Example 3 | Example 4 |
| Methacrylic resin | | | | | A | B | C | D | E | F | G | H | I |
| Methacrylic | 9-1 | Shaped piece | YI | [—] | 1.9 | 1.8 | 2.0 | 2.0 | 2.1 | 2.9 | 3.2 | 1.9 | 2.8 |
| resin | | color tone | Total light | [%] | 92.7 | 91.8 | 92.5 | 92.3 | 91.8 | 92.1 | 91.8 | 92.5 | 91.1 |
| shaped | | (3 mm | trans- | | | | | | | | | | |
| product | | optical | mittance | | | | | | | | | | |
| | | path | | | | | | | | | | | |
| | | length) | | | | | | | | | | | |
| | 9-2 | Shaped piece | YI | [—] | 28.2 | 27.5 | 32.1 | 30.1 | 29.5 | 38.1 | 40.2 | Not | 38.3 |
| | | color tone | | | | | | | | | | measured | |
| | | (80 mm | Y value | [—] | 69.2 | 66.3 | 67.5 | 69.3 | 68.2 | 59.2 | 58.1 | Not | 57.2 |
| | | optical path | | | | | | | | | | measured | |
| | | length) | | | | | | | | | | | |

The methacrylic resin shaped product according to the present embodiment has low YI over a long optical path, excellent color tone, and high transmittance. Therefore, the shaped product can suitably be used in optical component applications for light guide plates and the like and in automotive component applications for tail lamps, meter covers, head lamps, and the like.

### INDUSTRIAL APPLICABILITY

The presently disclosed methacrylic resin shaped product has high heat resistance, highly controlled birefringence, and excellent color tone and transparency.

The presently disclosed methacrylic resin shaped product can suitably be used as an optical material, for example, in light guide plates, diffuser plates, and polarizing plate protective films used in displays such as liquid-crystal displays, plasma displays, organic EL displays, field emission displays, and rear projection televisions; retardation plates such as quarter-wave plates and half-wave plates; liquid-crystal optical compensation films such as viewing angle control films; display front plates; display substrates; lenses; transparent conductive substrates such as touch panels and transparent substrates used in solar cells; applications in the fields of optical communication systems, optical switching systems, and optical measurement systems, or in optical products such as head mounted displays and liquid-crystal projectors for waveguides, lenses, lens arrays, optical fibers, and optical fiber coating materials; LED lenses; lens covers and the like, household goods, OA equipment, AV equipment, battery fittings, and lighting equipment; automotive component applications for tail lamps, meter covers, head lamps, light guide rods, lenses, car navigation system front plates, and the like; housing applications; and sanitary applications as a sanitary ware alternative or the like.

1. A methacrylic resin shaped product comprising a methacrylic resin or a composition containing the methacrylic resin, wherein
the methacrylic resin includes a structural unit (B) having a cyclic structure including at least one structural unit selected from the group consisting of an N-substituted maleimide structural unit (B-1) and a lactone ring structural unit (B-2) in a main chain,
the methacrylic resin has a glass transition temperature of higher than 120 □C and not higher than 160□C,
methanol-soluble content in the methacrylic resin is 5 mass % or less relative to 100 mass %, in total, of the methanol-soluble content and methanol-insoluble content, and
yellowness index (YI) measured with respect to a 20 w/v % chloroform solution of the methanol-insoluble content using a 10 cm optical path length cell is 0 to 7.

2. The methacrylic resin shaped product according to claim 1, wherein
transmittance at 680 nm measured with respect to a 20 w/v % chloroform solution of the methanol-insoluble content using a 10 cm optical path length cell is 90% or more.

3. The methacrylic resin shaped product according to claim 1, wherein
the methacrylic resin includes 50 mass % to 97 mass % of a methacrylic acid ester monomer unit (A) when the methacrylic resin is taken to be 100 mass %.

4. The methacrylic resin shaped product according to claim 1, wherein
the methacrylic resin includes 3 mass % to 30 mass % of the structural unit (B) having a cyclic structure in a main chain and 0 mass % to 20 mass % of another vinyl monomer unit (C) that is copolymerizable with a methacrylic acid ester monomer when the methacrylic resin is taken to be 100 mass %.

5. The methacrylic resin shaped product according to claim 1, wherein
content of the structural unit (B) is 45 mass % to 100 mass % when the structural unit (B) and the monomer unit (C) are taken to be 100 mass %, in total.

6. The methacrylic resin shaped product according to claim, wherein
the monomer unit (C) includes a structural unit of at least one selected from the group consisting of an acrylic acid ester monomer, an aromatic vinyl monomer, and a vinyl cyanide monomer.

7. The methacrylic resin shaped product according to claim 1, wherein
the methacrylic resin has a photoelastic coefficient of −2×10⁻¹² Pa⁻¹ to +2×10⁻¹² Pa⁻¹.

8. The methacrylic resin shaped product according to claim 1, wherein
the methacrylic resin has a ratio (Mz/Mw) of Z average molecular weight (Mz) and weight average molecular weight (Mw) of 1.3 to 2.0 as measured by gel permeation chromatography (GPC).

9. An optical or automotive component comprising the methacrylic resin shaped product according to claim 1.

10. The methacrylic resin shaped product according to claim 2, wherein
the methacrylic resin has a photoelastic coefficient of −2×10⁻¹² Pa⁻¹ to +2×10⁻¹² Pa⁻¹.

11. The methacrylic resin shaped product according to claim 2, wherein
the methacrylic resin has a ratio (Mz/Mw) of Z average molecular weight (Mz) and weight average molecular weight (Mw) of 1.3 to 2.0 as measured by gel permeation chromatography (GPC).

12. An optical or automotive component comprising the methacrylic resin shaped product according to claim 2.

13. The methacrylic resin shaped product according to claim 7, wherein
the methacrylic resin has a ratio (Mz/Mw) of Z average molecular weight (Mz) and weight average molecular weight (Mw) of 1.3 to 2.0 as measured by gel permeation chromatography (GPC).

14. An optical or automotive component comprising the methacrylic resin shaped product according to claim 7.

15. An optical or automotive component comprising the methacrylic resin shaped product according to claim 8.

16. The methacrylic resin shaped product according to claim 10, wherein
the methacrylic resin has a ratio (Mz/Mw) of Z average molecular weight (Mz) and weight average molecular weight (Mw) of 1.3 to 2.0 as measured by gel permeation chromatography (GPC).

17. An optical or automotive component comprising the methacrylic resin shaped product according to claim 10.

18. An optical or automotive component comprising the methacrylic resin shaped product according to claim 11.

19. An optical or automotive component comprising the methacrylic resin shaped product according to claim 16.
